(19) United States
(12) Patent Application Publication
(10) Pub. No.: US 2026/0343451 A1
(43) Pub. Date: Oct. 29, 2026

(54) MANAGING TIMING ALIGNMENT WITH MULTIPLE RECEIVERS IN A WIRELESS COMMUNICATION SYSTEM

(71) Applicant: GOOGLE LLC, Mountain View, CA (US)

(72) Inventors: Jia-Hong Liou, Mountain View, CA (US); Chih-Hsiang Wu, Taoyuan City (TW)

(21) Appl. No.: 19/099,750

(22) PCT Filed: Jul. 29, 2023
(86) PCT No.: PCT/US2023/029053

§ 371 Date: Jan. 29, 2025

Related U.S. Application Data
(60) Provisional application No. 63/393,591, filed on Jul. 29, 2022.
(60) Provisional application No. 63/393,818, filed on Jul. 29, 2022.

(51) Int. Cl. H04W 56/00; H04W 74/0833

(52) U.S. Cl. CPC H04W 56/0045; H04W 56/001; H04W 74/0833

(57) ABSTRACT

To manage synchronization, a user equipment receives, from a radio access network (RAN), a configuration including a first timing advance (TA) value and a second TA value (606); operates a first TA timer (TAT) corresponding to the first TA value to manage synchronization of first uplink (UL) transmissions with a first receiver in the RAN (608); operates a second TAT corresponding to the second TA value to manage synchronization of second UL transmission with a second receiver in the RAN (610); stops the first UL transmissions in response to the first TAT expiring (612); and stops the second UL transmissions in response to the second TAT expiring (614).

### CROSS-REFERENCE TO RELATED APPLICATIONS

This application claims priority to and the benefit of the filing date of provisional U.S. Patent Application No. 63/393,818 entitled “MAINTAINING A TA VALUE IN A MULTIPLE-TRP SCENARIO IN A WIRELESS COMMUNICATION SYSTEM,” filed on Jul. 29, 2022 and provisional U.S. Patent Application No. 63/393,591 entitled “MANAGING MULTIPLE TIMING ADVANCE VALUES FOR MULTIPLE TRANSMIT AND/OR RECEIVE POINTS,” filed on Jul. 29, 2022. The entire contents of the provisional application are hereby expressly incorporated herein by reference.

### FIELD OF THE DISCLOSURE

This disclosure relates generally to wireless communications and, more particularly, to maintaining a TA value in a serving cell at UE side or NW/Base Station (BS) side, and/or supporting updates and expirations of the time alignment timer (TAT). The techniques can apply to multiple-transmit-and/or-receive-points (M-TRP) scenarios.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In some such cases, the UE in the RRC_IDLE or RRC_INACTIVE state performs an early data transmission without transitioning to the RRC_CONNECTED state.

Regarding the PHY layer, in some cases, different channel or reference signal (RS) configurations correspond to different beam indication techniques. For most DL transmissions (e.g., physical downlink shared channel (PDSCH), physical downlink control channel (PDCCH), or channel state information (CSI) resource signal (CSI-RS)), a transmission configuration indication (TCI) framework and TCI states are applicable and configured for such transmissions. However, in some cases, PDCCH transmissions need a MAC-CE to further indicate a TCI state within the configured TCI states, and PDSCH transmissions similarly need a MAC-CE and downlink control information (DCI) for such. For a physical uplink shared channel (PUSCH), the UL beam indication relies on the index of a sounding reference signal (SRS) resource on which the UE has transmitted at least once. In some implementations, for a physical uplink control channel (PUCCH), a MAC-CE indicates spatial relation for a UE to derive a UL beam. In further implementations, a spatial relation is also configured in an SRS resource set, which indicates the same UL beam as applicable for all SRS resources in the SRS resource set. However, these messages may also require a large signaling overhead when many channels or RSs share the same beam.

### SUMMARY

An example embodiment of the techniques of this disclosure is a method for managing synchronization, the method implemented in a user equipment (UE) and comprising: receiving, from a radio access network (RAN), a configuration including a first timing advance (TA) value and a second TA value; operating a first TA timer (TAT) corresponding to the first TA value to manage synchronization of first uplink (UL) transmissions with a first receiver in the RAN; operating a second TAT corresponding to the second TA value to manage synchronization of second UL transmission with a second receiver in the RAN; stopping the first UL transmissions in response to the first TAT expiring; and stopping the second UL transmissions in response to the second TAT expiring.

Another example embodiment of these techniques is a user equipment (UE) comprising a transceiver and processing hardware configured to implement the method above.

### BRIEF DESCRIPTION OF THE DRAWINGS

FIG. 1A is a block diagram of an example system in which a distributed base station and/or a user equipment (UE) can implement the techniques of this disclosure;

FIG. 1B is a block diagram of an example base station including a central unit (CU) and a distributed unit (DU) of a distributed base station that can operate in the system of FIG. 1A;

FIG. 2A is a block diagram of an example protocol stack according to which the UE of FIGS. 1A-B can communicate with base stations;

FIG. 2B is a block diagram of an example protocol stack according to which the UE of FIGS. 1A-B can communicate with a DU and a CU of a base station;

FIG. 3A is a block diagram of a detailed structure of various sublayers of a protocol stack as depicted in FIGS. 2A and/or 2B, including a scheduling and/or priority handling function;

FIG. 3B is a block diagram of a detailed structure of various sublayers of a protocol stack, similar to FIG. 3A, but in which the structure includes a logical channel prioritization function;

FIG. 4A is a block diagram of a HARQ entity including a plurality of HARQ processes and communicating with a transport channel to a plurality of TRPs;

FIG. 4B is a block diagram of a HARQ entity similar to that of FIG. 4A, but in which the HARQ entity includes a plurality of HARQ process groups associated with a plurality of transport channels to a plurality of TRPs;

FIG. 4C is a block diagram of a HARQ entity similar to that of FIG. 4A, but in which the HARQ entity communicates with a single TRP;

FIG. 5A is a messaging diagram of an example scenario in which a UE synchronizes with a first TRP and/or a second TRP for performing communications with a base station;

FIG. 5B is a messaging diagram of an example scenario similar to FIG. 5A, but in which the UE receives UL and DL configuration parameters in separate radio resource configuration messages;

FIG. 5C is a messaging diagram of an example scenario similar to FIG. 5A, but in which the base station transmits the UL configuration parameters to the UE via the second TRP rather than the first TRP;

FIG. 5D is a messaging diagram of an example scenario similar to FIG. 5A, but in which the UE receives a response from the base station while performing a random access procedure via the first TRP rather than via the second TRP;

FIG. 5E is a messaging diagram of an example scenario similar to FIG. 5A, but in which the UE receives the PDCCH order via the first TRP rather than the second TRP;

FIG. 6 is a flow diagram of an example method in which a UE of FIGS. 1A and/or 1B determines whether to stop transmitting UL transmissions associated with a first or second TA value based on whether the UE detects that a first TAT or second TAT expires;

FIG. 7A is a flow diagram of an example method similar to FIG. 6, but in which the UE determines whether to flush HARQ buffers of a first or second set of HARQ processes based on the detection;

FIG. 7B is a flow diagram of an example method similar to FIG. 7A, but in which the UE determines whether to flush HARQ buffers associated with the first and second TA value or refrain from flushing the HARQ buffers based on the detection;

FIG. 8A is a flow diagram of an example method similar to FIG. 6, but in which the UE determines whether to clear configured UL grants associated with the first or second TA value based on the detection;

FIG. 8B is a flow diagram of an example method similar to FIG. 8A, but in which the UE determines whether to clear configured UL grants associated with the first and/or second TA value or refrain from clearing the configured UL grants based on the detection;

FIG. 9A is a flow diagram of an example method similar to FIG. 6, but in which the UE determines whether to release PUCCH resources associated with the first or second TA value based on the detection;

FIG. 9B is a flow diagram of an example method similar to FIG. 9A, but in which the UE determines whether to release PUCCH resources associated with the first and/or second TA value or refrain from releasing PUCCH resources based on the detection;

FIG. 10A is a flow diagram of an example method similar to FIG. 6, but in which the UE determines whether to release SRS resources associated with the first or second TA value based on the detection;

FIG. 10B is a flow diagram of an example method similar to FIG. 10A, but in which the UE determines whether to release SRS resources associated with the first and/or second TA value or refrain from releasing SRS resources based on the detection;

FIG. 11A is a flow diagram of an example method similar to FIG. 6, but in which the UE determines whether to clear PUSCH resources for CSI reporting associated with the first or second TA value based on the detection;

FIG. 11B is a flow diagram of an example method similar to FIG. 11A, but in which the UE determines whether to clear PUSCH resources for CSI reporting associated with the first and/or second TA value or refrain from clearing the PUSCH resources based on the detection;

FIG. 12A is a flow diagram of an example method similar to FIG. 6, but in which the UE determines whether to trigger a CBRA procedure associated with the first or second TA value based on the detection;

FIG. 12B is a flow diagram of an example method similar to FIG. 12A, but in which the UE determines whether to transmit a MAC CE indicating expiry of the first or second TA value based on the detection;

FIG. 12C is a flow diagram of an example method similar to FIG. 12A, but in which the UE determines whether to transmit an RRC message indicating expiry of the first or second TA value based on the detection;

FIG. 12D is a flow diagram of an example method similar to FIG. 12A, but in which the UE determines whether to transmit a PUCCH transmission indicating expiry of the first or second TA value based on the detection;

FIG. 12E is a flow diagram of an example method in which a UE of FIGS. 1A and/or 1B determines whether to transmit one of the transmissions in FIGS. 12B-12D indicating expiry of the first or second TA value or trigger a CBRA procedure based on whether the UE detects that a first TAT and/or second TAT expires;

FIG. 13 is a flow diagram of an example method in which a UE of FIGS. 1A and/or 1B receives a first and second TA value and starts or restarts a single TAT to maintain a first and second UL synchronization with the base station; and

FIG. 14 is a flow diagram of an example method in which a UE of FIGS. 1A and/or 1B receives a first TA value and a delta value from the base station, and subsequently determines a second TA value based on the first TA value and delta value.

### DETAILED DESCRIPTION OF THE DRAWINGS

The techniques discussed below can apply to M-TRP scenarios that involve multiple timing advance (TA) values, where a UE maintains multiple TA values in at least one serving cell. The approaches discussed below allow a UE and/or a base station to maintain TA alignment in an M-TRP scenario. These techniques also allow a UE to indicate/update a TA value for various TAT operation framework(s). These techniques can apply to LTE, NR, or any other suitable RAT.

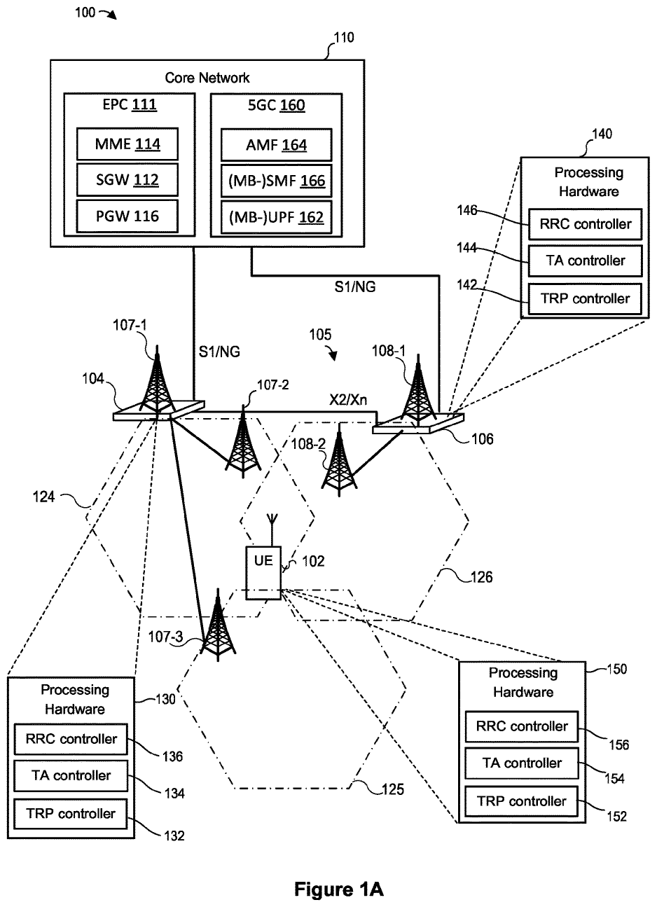

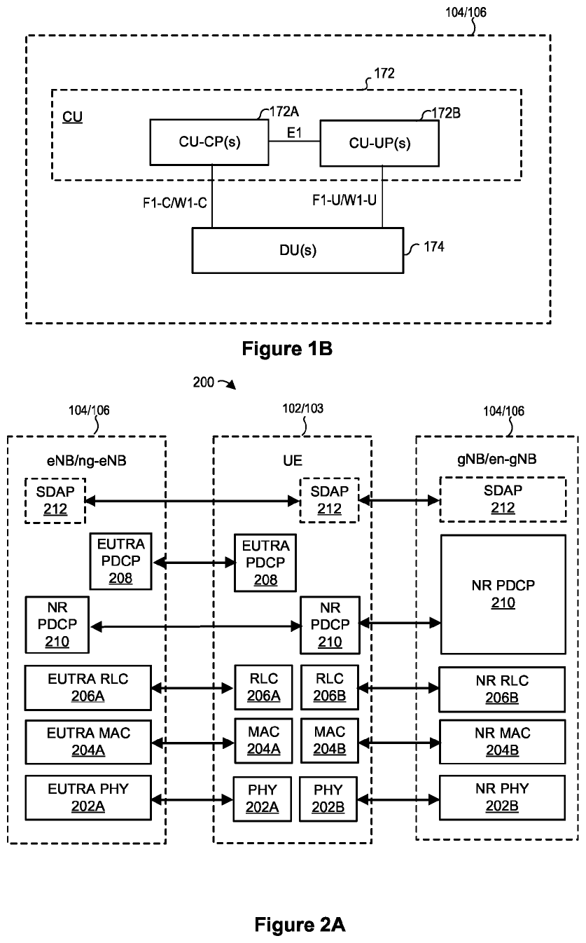

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 can cover one or more cells (e.g., cells 124 and 125) with one or more transmit and/or receive points (TRPs), and the base station 106 can similarly cover one or more cells (e.g., cell 126) with one or more TRPs. For example, the base station 104 operates cell 124 with TRPs 107-1 and 107-2 and operates cell 125 with TRP 107-3, and the base station 106 operates cell 126 with TRPs 108-1 and 108-2. The cells 124 and 125 are operated on the same carrier frequency/frequencies. The cell 126 can be operated on the same carrier frequency/frequencies as the cells 124 and 125. Alternatively, the cell 126 can be operated on different carrier frequency/frequencies from the cells 124 and 125. In some implementations, the base station 104 connects each of the TRPs 107-1, 107-2 and 107-3 via a fiber connection or an Ethernet connection. If the base station 104 is a gNB, the cells 124 and 125 are NR cells. If the base station 104 is an (ng-)eNB, the cells 124 and 125 are evolved universal terrestrial radio access (EUTRA) cells. Similarly, if the base station 106 is a gNB, the cell 126 is an NR cell, and if the base station 106 is an (ng-)eNB, the cell 126 is an EUTRA cell. The cells 124, 125, and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base station 104 via the TRP 107-1, TRP 107-2 and/or TRP-3. Similarly, the UE 102 can support at least a 5G NR (or simply, “NR”) or E-UTRA air interface to communicate with the base station 106 via the TRP 108-1 and/or TRP 108-2. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

When a base station (e.g., the base station 104 or 106) transmits DL data via a TRP (e.g., the TRP 107-1, TRP 107-2, TRP 107-3, TRP 108-1 or TRP 108-2), the base station 104 can generate a packet including the data transmit the packet to the TRP 107-1. For example, the packet can be a fronthaul transport protocol data unit. The TRP extracts the data from the packet and transmits the data. In some implementations, the base station 104 can include control information for time-critical control and management information directly related to the data in the packet, and the TRP can transmit the data in accordance with the control information. In some implementations, the data includes In-phase and Quadrature (IQ) data, a physical layer bit sequence, or a MAC PDU. When the TRP receives data from a UE (e.g., UE 102), the TRP generates a packet including the data and transmit the packet to the base station 104. In some implementations, the data includes IQ data, a physical layer bit sequence, or a MAC PDU.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cells 124 and 125, and the base station 106 supports a cell 126. The cells 124, 125, and 126 can partially overlap, so that the UE 102 can select, reselect, or hand over from one of the cells 124, 125, and 126 to another. To directly exchange messages or information, the base station 104 and base station 106 can support an X2 or Xn interface. In general, the CN 110 can connect to any suitable number of base stations supporting NR cells and/or EUTRA cells.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical DL channels and DL reference signals with one or more user devices (e.g., UE 102) via one or more TRPs (e.g., TRP 107-1, TRP 107-2 and/or TRP 107-3). The PHY controller 132 is also configured to receive data and control signal on physical UL channels and/or UL reference signals with the one or more user devices via the one or more TRPs (e.g., TRP 107-1, TRP 107-2 and/or TRP 107-3). The processing hardware 130 in an example implementation includes a MAC controller 134 configured to perform a random access (RA) procedure with one or more user devices, manage UL timing advance for the one or more user devices, receive UL MAC PDUs from the one or more user devices, and transmit DL MAC PDUs to the one or more user devices. The processing hardware 130 can further include an RRC controller 136 to implement procedures and messaging at the RRC sublayer of the protocol communication stack. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more TRPs (e.g., TRP 107-1, TRP 107-2, TRP 107-3, TRP 108-1 and/or TRP 108-2). The PHY controller 152 is also configured to transmit data and control signal on physical UL channels and/or UL reference signals with the base station 104 or 106 via the one or more TRPs (e.g., TRP 107-1, TRP 107-2, TRP 107-3, TRP 108-1 and/or TRP 108-2). The processing hardware 150 in an example implementation includes a MAC controller 154 configured to perform a random access procedure with base station 104 or 106, manage UL timing advance for the one or more user devices, transmit UL MAC PDUs to the base station 104 or 106, and receive DL MAC PDUs from the base station 104 or 106. The processing hardware 150 can further include an RRC controller 156 to implement procedures and messaging at the RRC sublayer of the protocol communication stack.

FIG. 1B depicts an example distributed or disaggregated implementation of one or both of the base stations 104, 106. In this implementation, each of the base station 104 and/or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller (e.g., PDCP controller 134, 144), an RRC controller (e.g., RRC controller 136, 146), and/or an RRC inactive controller (e.g., RRC inactive controller 138, 148). In some implementations, the CU 172 can include an RLC controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The processing hardware can also include a physical layer controller configured to manage or control one or more physical layer operations or procedures.

In some implementations, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or SDAP protocol of the CU 172. The CU-CP 172A can transmit control information (e.g., RRC messages, F1 application protocol messages), and the CU-UP 172B can transmit data packets (e.g., SDAP PDUs or IP packets).

The CU-CP 172A can be connected to multiple CU-UPs 172B through the E1 interface. The CU-CP 172A selects the appropriate CU-UP 172B for the requested services for the UE 102. In some implementations, a single CU-UP 172B can be connected to multiple CU-CPs 172A through the E1 interface. If the CU-CP 172A and DU(s) 174 belong to a gNB, the CU-CP 172A can be connected to one or more DU 174s through an F1-C interface and/or an F1-U interface. If the CU-CP 172A and DU(s) 174 belong to an ng-eNB, the CU-CP 172A can be connected to DU(s) 174 through a W1-C interface and/or a W1-U interface. In some implementations, one DU 174 can be connected to multiple CU-UPs 172B under the control of the same CU-CP 172A. In such implementations, the connectivity between a CU-UP 172B and a DU 174 is established by the CU-CP 172A using Bearer Context Management functions.

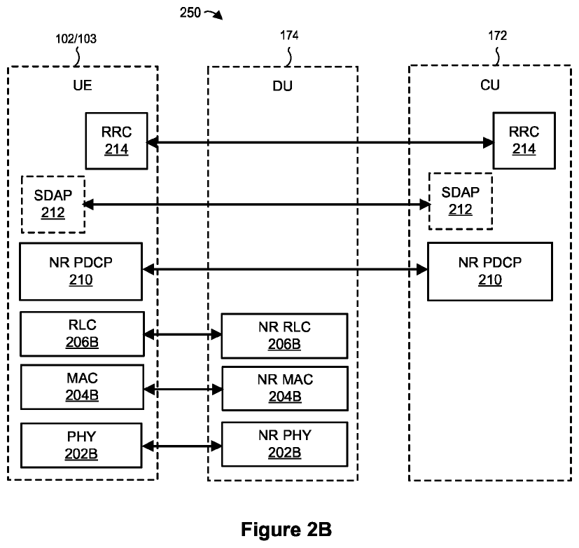

FIG. 2A illustrates, in a simplified manner, an example protocol stack 200 according to which the UE 102 can communicate with an eNB/ng-eNB or a gNB (e.g., one or both of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to the SDAP sublayer 212 or an RRC sublayer (not shown in FIG. 2A). The UE 102, in some implementations, supports both the EUTRA and the NR stack as shown in FIG. 2A, to support handover between EUTRA and NR base stations and/or to support dual connectivity (DC) over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an IP layer, layered directly or indirectly over the PDCP layer 208 or 210) that can be referred to as SDUs, and output packets (e.g., to the RLC layer 206A or 206B) that can be referred to as PDUs. Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) to the RRC sublayer (not shown in FIG. 2A) to exchange RRC messages or NAS messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, IP packets, or Ethernet packets.

Thus, it is possible to functionally split the radio protocol stack, as shown by the radio protocol stack 250 in FIG. 2B. The CU at one or both of the base stations 104, 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

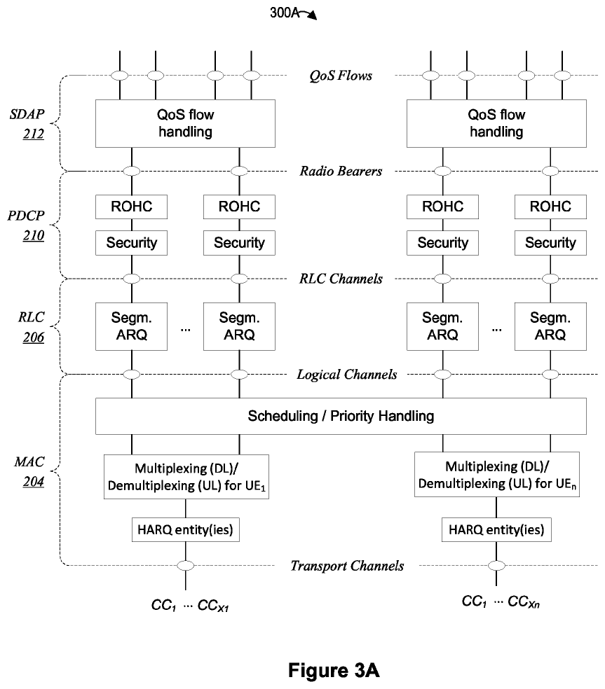

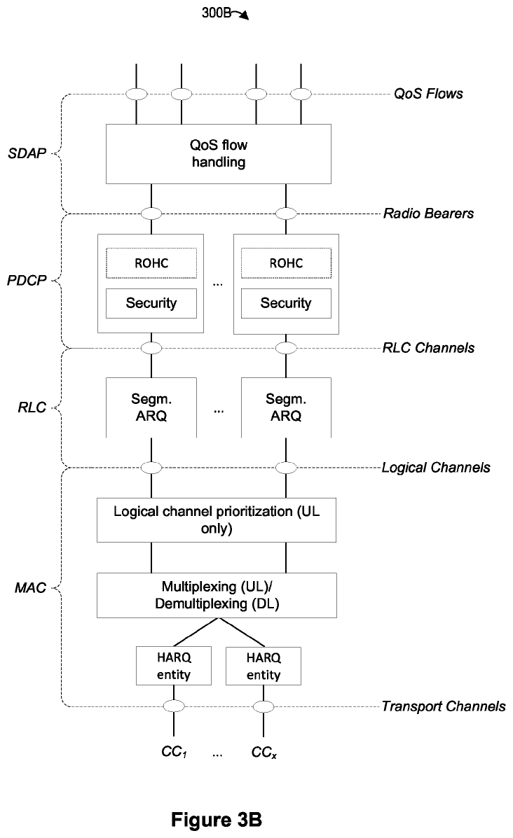

FIG. 3A illustrates a detailed structure 300A of the NR layer 2 protocol stack 200 or 250 for the base station 104 or 106. The PHY 202 (not shown in FIG. 3A) provides transport channels to the MAC sublayer 204. The MAC sublayer 204 includes a scheduling and/or priority handling function for scheduling and/or prioritizing DL and UL transmissions with one or more user devices. The MAC sublayer 204 also includes a multiplexing function for DL transmission and/or a demultiplexing function for UL transmission with a particular user device. The MAC sublayer 204 further includes Hybrid Automatic Repeat reQuest (HARQ) entities each for DL transmissions and/or UL transmissions on a particular DL component carrier (CC) and/or a particular UL CC with a particular user device. The RLC sublayer 206 includes segmentation and Automatic Repeat reQuest (ARQ) functions for DL data and UL data communicated with one or more UEs. The PDCP sublayer 210 provides radio bearers to the SDAP sublayer 212 and includes (i) security and (ii) robust header compression (ROHC) functions for (i) integrity protection and/or encryption/description and (ii) header compression/decompression, respectively. The SDAP sublayer 212 provides 5GC QoS flows to upper layer(s).

FIG. 3B illustrates a detailed structure 300B of the NR layer 2 protocol stack 200 or 250 for the UE 102, similar to structure 300A. The PHY 202 (not shown in FIG. 3B) provides, to the MAC sublayer 204, transport channels for DL and UL transmission with the base station(s) 104 or 106. The MAC sublayer 204 includes one or more HARQ entities each for DL transmissions and/or UL transmissions on a particular DL CC and/or a particular UL CC with the base station(s) 104 or 106. The MAC sublayer 204 also includes logical channel prioritization and multiplexing functions for UL transmission to the base station(s) 104 or 106 and includes a demultiplexing function for DL transmission from the base station(s) 104 or 106. The RLC sublayer 206 includes segmentation and Automatic Repeat reQuest (ARQ) functions for DL data and UL data communicated with the base station(s) 104 and/or 106. The PDCP sublayer 210 provides radio bearers to the SDAP sublayer 212 and includes (i) security and (ii) robust header compression (ROHC) functions for (i) integrity protection and/or encryption/description and (ii) header compression/decompression, respectively. The SDAP sublayer 212 provides 5GC QoS flows to upper layer(s).

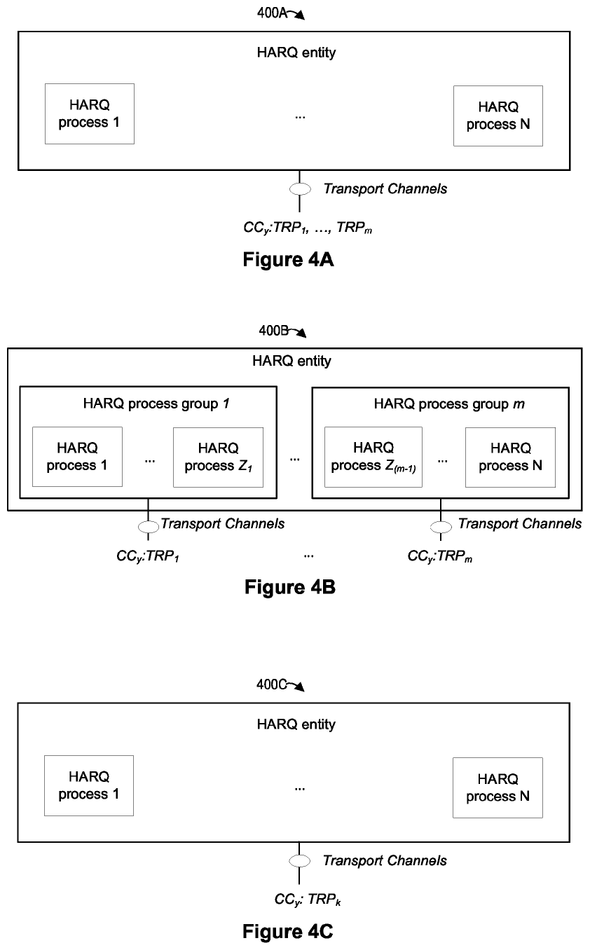

FIGS. 4A-4C illustrate different implementations of a HARQ entity for multiple TRP (mTRP) operation on a particular CCy (e.g., UL CC or DL CC), which can be implemented in the UE 102, the base station 104 or 106, or the DU 174 of the base station 104 or 106.

Referring first to FIG. 4A which depicts a HARQ entity 400A. In some implementations, the HARQ entity 400A includes HARQ processes 1, . . . , N for communication with TPRs 1 . . . , m. N is an integer and larger than zero, and m is an integer and larger than zero. For example, N is 8, 16, 32, etc., and m is 2, 3 4, etc.

Next, FIG. 4B depicts further implementations of a HARQ entity 400B, similar to the HARQ entity 400A. The difference between the implementations of HARQ entities 400B and 400A is that the HARQ entity 400B partitions the HARQ processes 1, . . . , N into m groups, where each is used for communication with a particular TRP.

Next, FIG. 4C depicts an implementation of a HARQ entity 400C (e.g., HARQ entity k), similar to the HARQ entity 400A. The difference between the implementations of HARQ entities 400C and 400A is that the HARQ entity 400C is used for communication with a particular TRP (e.g., TRPₖ) on a particular CC (e.g., CCₖ), where 1<=k<=m. In other words, the UE 102 uses HARQ entity 1, . . . , m to communicate with a RAN node (e.g., the base station 104 or 106, or DU 174) via TRPs 1, . . . , m on each UL CC, respectively. Similarly, the RAN node uses HARQ entity 1, . . . , m to communicate with the UE 102 via TRPs 1, . . . , m of the RAN node (e.g., the base station 104 or 106, or DU 174) on each DL CC, respectively.

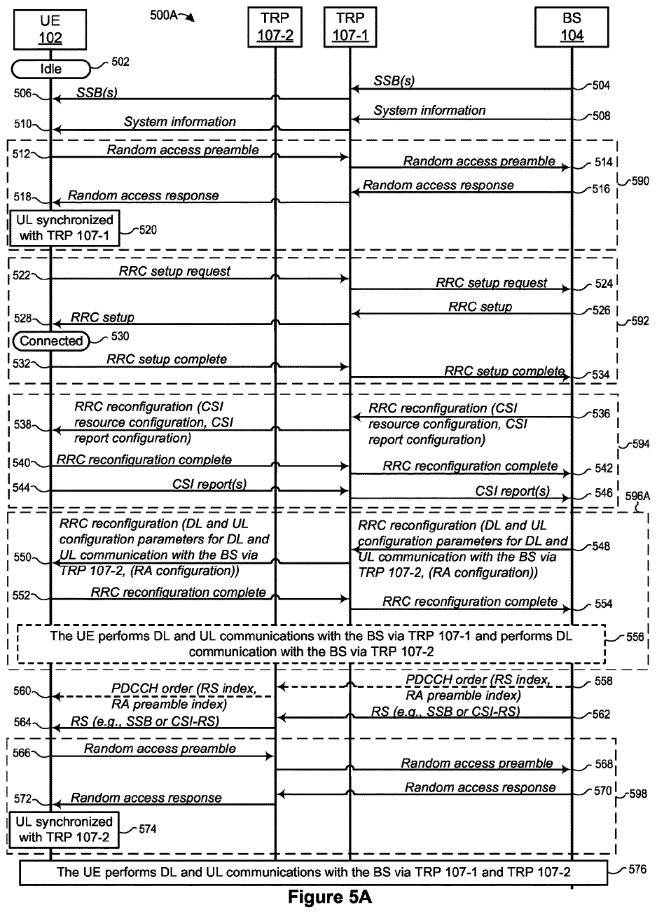

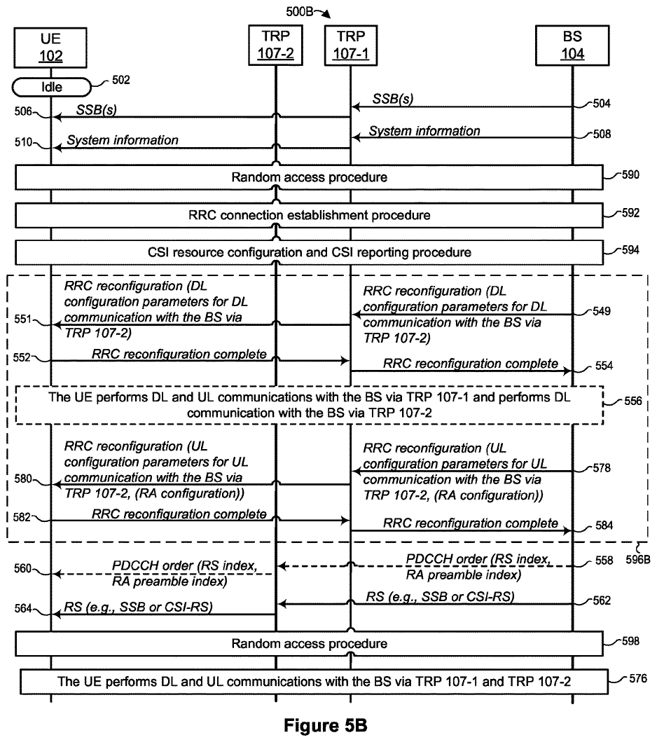

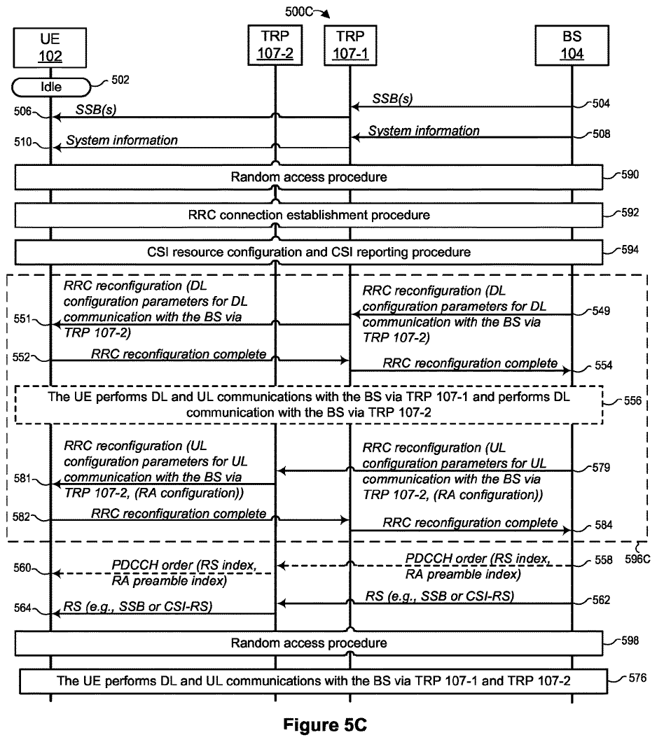

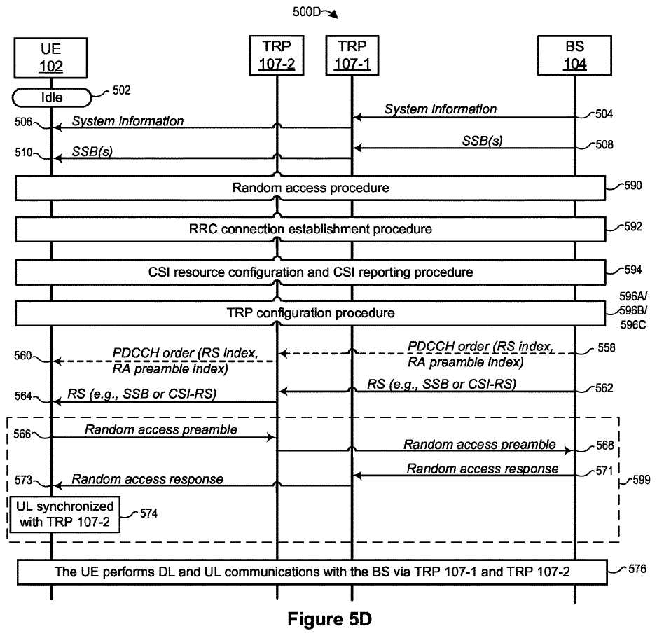

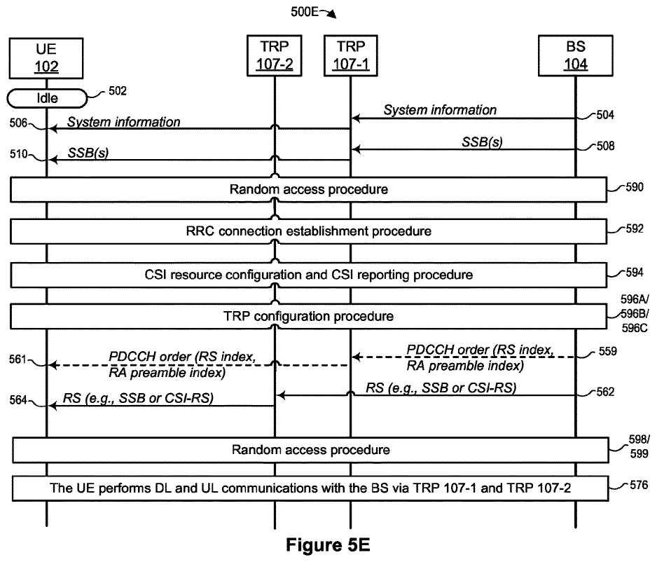

Next, several example scenarios that involve various components of FIG. 1A and relate to mTRP operation are discussed with reference to FIGS. 5A-5E. Generally, events in FIGS. 5A-5E that can be the same are labeled with the same reference numbers.

Referring first to FIG. 5A, in a scenario 500A, a base station 104 operates the cell 124, the TRP 107-1, and TRP 107-2. In the scenario 500A, the base station 104 broadcasts (e.g., periodically) 504, 506 one or more synchronization signal blocks (SSB(s)) and 508, 510 system information via the TRP 107-1. In some implementations, the system information includes master information block(s) (MIB) and/or system information block(s) (SIB(s)). In some examples, the SIB(s) include an SIB1 and further include an SIB2, SIB3, SIB4, and/or SIB5. The UE 102 initially operates 502 in an idle state (e.g., RRC_IDLE state). The UE 102 in the idle state receives 504, 506 the SSB(s) and 508, 510 the system information from the base station 104 via the TRP 107-1. In some implementations, the UE 102 detects that the base station 104 transmits the SSB(s) via the TRP 107-1. In some implementations, the UE 102 then uses one of the SSB(s) to perform downlink synchronization on the cell 124 with the base station 104 via the TRP 107-1, and receives 508, 510 the system information via the TRP 107-1 based on the SSB.

Later in time, the UE 102 determines to perform 590 a random access procedure to perform 592 an RRC connection establishment procedure. In response to the determination, the UE 102 transmits 512 a first random access preamble on a time/frequency resource and/or a random access channel (RACH) occasion to the TRP 107-1. The TRP 107-1 then forwards 514 the first random access preamble to the base station 104. In some implementations, the UE 102 selects an SSB from the SSB(s), for which an RSRP obtained by the UE 102 is above a first threshold (e.g., rsrp-ThresholdSSB), for the random access procedure. In other implementations, in cases where an RSRP for any SSB in the SSB(s) is not above the first threshold, the UE 102 selects an SSB from the SSB(s) and uses the SSB to determine the first random access preamble. In some such cases, the UE 102 selects the SSB from the SSB(s) randomly, or selects based on a UE-implementation. The UE 102 then determines the first random access preamble, time/frequency resource, and/or RACH occasion based on the selected SSB and random access configuration parameters included in the system information (e.g., the SIB1). In some implementations, the random access configuration parameters indicate one or more associations between (i) SSB(s) and (ii) random access preamble(s), RACH occasion(s), and/or time/frequency resource(s). Based on the selected SSB and the association(s), the UE 102 determines the first random access preamble, the RACH occasion, and/or time/frequency resource(s) to transmit the first random access preamble.

In response to the first random access preamble, the base station 104 transmits 516 a first random access response to the TRP 107-1. The TRP 107-1 then forwards 518 the first random access response to the UE 102. In some implementations, the base station 104 or TRP 107-1 identifies an SSB associated with the first random access preamble, RACH occasion, and/or time/frequency resource. In some cases where a single SSB is associated with the first random access preamble, RACH occasion, and/or time/frequency resource, the identified SSB is the SSB selected by the UE 102. In some cases where multiple SSBs are associated with the first random access preamble, RACH occasion, and/or time/frequency resource, the identified SSB is the same as or different from the SSB selected by the UE 102. In such implementations, the base station 104 transmits the first random access response to the UE 102 via the TRP 107-1, based on the identified SSB. The base station 104 includes a first preamble ID and a first TA command in the first random access response. The first preamble ID identifies the first random access preamble, and the first TA command includes a first TA value. The UE applies the first TA value and determines or maintains 520 an uplink that is synchronized (e.g., time aligned) with the TRP 107-1 after (e.g., in response to) applying the first TA value. The UE 102 applies the first TA value for transmitting UL transmissions (e.g., PUCCH transmissions, PUSCH transmissions, and/or sounding reference signal transmissions) until a new or different TA value is received from base station 104 that updates the first TA value. In some implementations, the UE 102 starts a first time alignment timer (TAT) to maintain a UL synchronization status with the TRP 107-1 or base station 104 after or upon receiving the first TA command. In some implementations, the base station 104 includes a UL grant (i.e., an RAR grant) in the random access response.

In some implementations, the base station 104 starts a first TAT to maintain a first UL synchronization for UL and/or DL communication with the UE 102 via the TRP 107-1 after transmitting the random access response or the first TA command to the UE 102. In some implementations, the TRP 107-1 generates timing information for or based on the first random access preamble received from the UE 102 and transmits the timing information to the base station 104. In some examples, the timing information indicates a propagation delay or a propagation delay shift. Based on the timing information received from the TRP 107-1, the base station 104 determines the first TA value.

The blocks 512, 514, 516, 518, and 520 are collectively referred to in FIG. 5A as a random access procedure 590.

During or after the random access procedure 590, the UE 102 transmits 522, 524 an RRC setup request message (e.g., RRCSetupRequest message) to the base station via the TRP 107-1. In some implementations, the UE 102 transmits the RRC setup request message using the UL grant received in the random access response. In response to the RRC setup request message, the base station 104 transmits 526, 528 an RRC setup message (e.g., RRCSetup message) to the UE 102 via the TRP 107-1. In some implementations, the base station 104 transmits a MAC PDU including contention resolution (e.g., MAC control element (CE)) to the UE 102 to resolve a contention for the random access procedure. In some implementations, the base station 104 includes the RRC setup message in the MAC PDU. In further implementations, after transmitting the MAC PDU, the base station 104 transmits another MAC PDU, including the RRC setup message, to the UE 102. In response to the RRC setup message, the UE 102 transitions 530 to a connected state (e.g., RRC_CONNECTED) and transmits 532, 534 an RRC setup complete message (e.g., RRCSetupComplete message) to the base station 104 via the TRP 107-1. In some implementations, after performing the RRC connection establishment procedure with the UE 102, the base station 104 performs a security activation procedure with the UE 102 to activate security protection (e.g., integrity protection/integrity check and encryption/decryption) for UL data and DL data communicated between the UE 102 and basc station 104. In further implementations, after performing the RRC connection establishment procedure or security activation procedure, the base station 104 performs a radio bearer configuration procedure with the UE 102 to configure an SRB2 and/or a DRB for the UE 102.

After performing the RRC connection establishment procedure, security activation procedure or radio bearer configuration procedure, the base station 104 transmits 536, 538, to the UE 102 via the TRP 107-1, an RRC reconfiguration message (e.g., RRCReconfiguration message) including a channel state information (CSI) resource configuration and a CSI reporting configuration. In response, the UE 102 transmits 540, 542 an RRC reconfiguration complete message (e.g., RRCReconfigurationComplete message) to the base station 104 via the TRP 107-1. In some implementations, the CSI resource configuration includes configuration parameters configuring channel state information reference signal(s) (CSI-RS(s)) for the UE 102 to measure. The base station 104 transmits the CSI-RS(s) via the TRP 107-2 in accordance with the CSI resource configuration. The UE 102 performs measurements on the CSI-RS(s) in accordance with the CSI resource configuration. In some implementations, the CSI resource configuration includes configuration parameters configuring SSB(s) for the UE 102 to measure. The base station 104 transmits the SSB(s) via the TRP 107-2. The UE 102 performs measurements on the SSB(s) in accordance with the CSI resource configuration. In other implementations, the RRC reconfiguration message or CSI resource configuration does not include configuration parameters configuring SSB(s). In some such cases, the base station 104 still transmits SSB(s) via the TRP 107-2, and the UE 102 performs measurements on the SSB(s). Based on the CSI reporting configuration, the UE 102 generates CSI report(s) from the measurements of the CSI-RS(s) or the SSB(s) and transmits 544, 546 the CSI report(s) to the base station 104 via the TRP 107-1. In some implementations, the UE 102 transmits the CSI report(s) on a PUCCH to the base station 104 via the TRP 107-1. In some implementations, the CSI reporting configuration configures a periodic or semi-persistent reporting, or the CSI reporting configuration configures a semi-persistent or aperiodic reporting triggered by a DCI. The CSI report(s) include periodic CSI report(s), semi-persistent CSI report(s), and/or aperiodic CSI report(s).

In some implementations, the base station 104 includes the CSI resource configuration and/or the CSI report configuration in a CSI measurement configuration (e.g., CSI-MeasConfig IE). The base station 104 then includes the CSI measurement configuration in the RRC reconfiguration message of events 536, 538. In other implementations, the CSI resource configuration includes NZP-CSI-RS-Resource IE(s), NZP-CSI-RS-ResourceSet IE(s), CSI-SSB-ResourceSet IE(s), CSI-ResourceConfig IE(s), and/or CSI-ReportConfig IE(s).

The blocks 536, 538, 540, 542, 544, and 546 are collectively referred to in FIG. 5A as a CSI resource configuration and CSI reporting procedure 594.

After receiving the CSI report(s) at event 546, the base station 104 determines to communicate with the UE 102 via the TRP 107-2 based on the CSI report(s) while maintaining the link with the UE 102 via the TRP 107-1. In some implementations, the base station 104 makes the determination based on one or more capabilities of the UE 102. In response to the determination, the base station 104 transmits 548, 550, to the UE 102 via the TRP 107-1, an RRC reconfiguration message that includes DL and UL configuration parameters for DL and UL communication with the base station 104 via TRP 107-2, respectively. In some implementations, the base station 104 includes the DL and UL configuration parameters in a CellGroupConfig IE and includes the CellGroupConfig IE in the RRC reconfiguration message. In some implementations, the base station 104 includes the DL configuration parameters in a bandwidth part (BW) IE, such as a BWP-DownlinkDedicated IE, and includes the BWP-DownlinkDedicated IE in the RRC reconfiguration message. In some implementations, the base station 104 includes the UL configuration parameters in a BWP-UplinkDedicated IE and includes the BWP-UplinkDedicated IE in the RRC reconfiguration message.

In response to the RRC reconfiguration complete message, the UE 102 transmits 552, 554 an RRC reconfiguration complete message to the base station 104 via the TRP 107-1. In some implementations, the UE 102 applies the DL configuration parameters upon receiving the RRC reconfiguration message at event 554. In such implementations, the UE 102 performs 556 DL communication with the base station 104 via the TRP 107-2 in accordance with the DL configuration parameters, while performing DL and UL communications with the base station 104 via TRP 107-1. In some implementations, the UE 102 refrains from performing UL communication in accordance with the UL configuration parameters until after performing the random access procedure with the base station 104 via the TRP 107-2 at event 598. In further implementations, the UE 102 refrains from performing DL communication with the base station 104 via the TRP 107-2 until after performing the random access procedure with the base station 104 via the TRP 107-2 at event 598. In some implementations, the base station 104 refrains from performing UL communication and/or configuring the UL configuration parameters until after the random access procedure with the base station 104 via the TRP 107-2 at event 598 is completed. In some implementations, the base station 104 refrains from performing DL communication and/or configuring the DL configuration parameters until after the random access procedure with the base station 104 via the TRP 107-2 at event 598 is completed.

In some implementations, the base station 104 and UE 102 use a HARQ entity in FIGS. 4A, 4B, or 4C to perform DL communication with the base station 104 via the TRP 107-1 and TRP 107-2 at event 556. In some cases, such as with the HARQ entity 400B of FIG. 4B, the DL configuration parameters of events 548, 550 include HARQ configuration parameters. The HARQ configuration parameters configure a first set of HARQ processes IDs and a second set of HARQ processes IDs. In some cases, the first set of HARQ processes IDs and the second set of HARQ processes IDs are for the TRP 107-1 and the TRP 107-2, respectively. The first set of HARQ processes IDs and second set of HARQ processes IDs identify a first set of HARQ processes of the HARQ entity and a second set of HARQ processes of the HARQ entity, respectively. In some implementations, none of the first set of HARQ processes IDs and second set of HARQ processes IDs are identical. In other implementations, some of the first set of HARQ processes IDs and second set of HARQ processes IDs are identical and the others are different.

In some implementations, the base station 104 transmits, to the UE 102, one or more MAC control elements (CEs) or DCIs to change or update one or more HARQ process IDs in the first set of HARQ processes IDs. In some implementations, the base station 104 transmits, to the UE 102, one or more MAC CEs or DCIs to change or update one or more HARQ process IDs in the second set of HARQ processes IDs. In some alternative implementations, the base station 104 does not configure the first set of HARQ processes IDs and second set of HARQ processes IDs in the DL configuration parameters. In some implementations, the base station 104 determines the first set of HARQ processes IDs and second set of HARQ processes IDs for mTRP operation based on a pre-configuration. In further implementations, the first set of HARQ processes IDs and second set of HARQ processes IDs are specific, pre-determined IDs (e.g., as specified in a 3GPP specification). In yet further implementations, the base station 104 determines the first set of HARQ processes IDs and second set of HARQ processes IDs based on a rule.

In some implementations, when the base station 104 determines to schedule the UE 102 to receive a DL transmission to the TRP 107-1, the base station 104 selects a HARQ process ID from the first set of HARQ processes IDs and transmits a DCI, including a DL assignment, and the selected HARQ process ID to the UE 102. The UE 102 uses a HARQ process identified by the selected HARQ process ID and receives a DL transmission from the base station 104 using the HARQ process and UL grant. Similarly, when the base station 104 determines to schedule the UE 102 to transmit a UL transmission to the TRP 107-2, the base station 104 selects a HARQ process ID from the second set of HARQ processes IDs and transmits a DCI, including a UL grant, and the selected HARQ process ID to the UE 102. The UE 102 uses a HARQ process identified by the selected HARQ process ID and receives a DL transmission from the base station 104 using the HARQ process and DL assignment.

In some implementations, the one or more capabilities include at least one first capability indicating that the UE 102 supports mTRP operation (e.g., release 16 capability field(s)/IE(s) and/or release 17 capability field(s)/IE(s) in 3GPP specification 38.306 or 38.331 v17.1.0 or later versions for mTRP operation). In some implementations, the base station 104 determines to configure the DL configuration parameters for DL communication with the base station 104 via the TRP 107-2 based on the at least one first capability. In some implementations, the base station 104 determines the UL configuration parameters for UL communication with the base station 104 via the TRP 107-2 based on the at least one first capability. In cases where the base station 104 includes a DU 174 and a CU 172, the DU 174 makes the determination(s).

In some implementations, the one or more capabilities include at least one second capability. In some such implementations, the at least one second capability indicates that the UE 102 supports multiple UL transmission timings (i.e., operation of two or more TAs) for mTRP operation with a serving cell. In further implementations, the at least one second capability indicates that the UE 102 supports multiple UL transmission timings (for mTRP operation) with a serving cell and a non-serving cell. A Physical Cell Index (PCI) of the non-serving cell is different from a PCI of the serving cell. In some implementations, the least one second capability includes the number of UL transmission timings that the UE 102 support (for mTRP operation) with a serving cell and/or across all serving cell(s) configured/activated for the UE 102. In further implementations, the at least one second capability does not include the number of UL transmission timings (for mTRP operation) and indicates that the UE 102 supports a default number (e.g., 2) of UL transmission timings. In some implementations, the base station 104 determines to configure the UL configuration parameters for UL communication with the base station 104 via the TRP 107-2 based on the at least one second capability. In cases where the base station 104 includes a DU 174 and a CU 172, the DU 174 makes the determination.

In some implementations, the base station 104 receives the one or more capabilities from the UE 102, after receiving the RRC setup complete message or performing the security activation procedure with the UE 102. In some implementations, the base station 104 transmits a UE capability enquiry message (e.g., UECapabilityEnquiry message) to the UE 102 and receives a UE capability information message (e.g., UECapabilityInformation message) including the one or more capabilities from the UE in response.

In other implementations, the base station 104 receives a CN-to-BS message including the one or more capabilities from the CN 110 (e.g., after receiving the RRC setup complete message). In some implementations, the base station 104 transmits a BS-to-CN message to the CN 110 after receiving the RRC setup complete message and the CN 110 transmits the CN-to-BS message after (e.g., in response to) receiving the BS-to-CN message. In some implementations, the UE 102 transmits a NAS message (e.g., Registration Request message or Registration Complete message), including a capability ID identifying the one or more capabilities, to the CN 110, and the CN 110 obtains the one or more capabilities from the capability ID. In other implementations, the UE 102 performs a registration procedure with the CN 110 via a base station (e.g., the base station 104 or 106) before event 502 to register to the CN 110. During the registration procedure, the UE 102 receives a UE capability enquiry message (e.g., UECapabilityEnquiry message) from the base station and transmits a UE capability information message (e.g., UECapabilityInformation message), including the one or more capabilities, to the base station. The base station transmits a BS-to-CN message, including the one or capabilities, to the CN 110, and the CN 110 stores the one or more capabilities. In some implementations, the CN-to-BS message and BS-to-CN messages are NG application protocol (NGAP) messages. In cases where the base station 104 includes a DU 174 and a CU 172, the CU 172 transmits a CU-to-DU message including the one or more capabilities to the DU 174. In some implementations, the CU-to-DU message is an F1 application protocol (F1AP) message.

In some implementations, the base station 104 can include, in the RRC reconfiguration message, random access configuration parameters for the UE 102 to perform 598 the random access procedure. In some implementations, the random access configuration parameters are dedicated to the UE 102. For example, the base station 104 generates a RACH configuration (e.g., RACH-ConfigDedicated, RACH-ConfigDedicated-r18, or RACH-ConfigDedicated-v1800 IE) including the random access configuration parameters dedicated to the UE 102. In some implementations, the format of an RRCReconfiguration message includes ReconfigurationWithSync IE and the ReconfigurationWithSync IE includes a RACH-ConfigDedicated IE (e.g., a RACH configuration or including random access configuration parameters) (e.g., as specified in 3GPP specification 38.331 v17.0.0 or later versions). In cases where the RRC reconfiguration message is an RRCReconfiguration message, the base station 104 includes, in the RRCReconfiguration message, the RACH configuration or the random access configuration parameters for the RRCReconfiguration message, without including a ReconfigurationWithSync IE and wrapping the RACH configuration or the random access configuration parameters in the ReconfigurationWithSync IE. If the base station 104 uses the ReconfigurationWithSync IE to include the random access configuration parameters, the ReconfigurationWithSync IE causes the UE 102 to perform a handover, which causes an interruption in the communication between the UE 102 and the base station 104. In other implementations, the base station 104 refrains from including random access configuration parameters in the RRC reconfiguration message.

In some implementations, the base station 104 indicates that UL synchronization is required in the RRC reconfiguration message (i.e., for communication with the base station 104 over the second TRP). That is, the base station 104 configures the UE 102 to obtain (second) UL synchronization for communication between the UE 102 and TRP 107-1 while maintaining the first UL synchronization for communication between the UE 102 and TRP 107-2. In other words, the base station 104 configures the UE to maintain two TA values for communications between the UE 102 and base station 104 (e.g., between the UE 102 and TRP 107-1 and between the UE 102 and TRP 107-2, respectively). In further implementations, the base station 104 includes, in the RRC reconfiguration message, a configuration (e.g., a field or IE (e.g., RRC Release 18 field or IE)), indicating that UL synchronization is required for communication between the UE 102 and TRP 107-2. In other words, the configuration enables operation of two TA values for communications between the UE 102 and base station 104 (e.g., between the UE 102 and TRP 107-1 and between the UE 102 and TRP 107-2, respectively).

In some implementations, the UE 102 initiates the random access procedure 598 in response to receiving the the field or IE, before transmitting UL transmissions (e.g., channel state information (CSI) report, a sounding reference signal (SRS), PUCCH transmissions, and/or PUSCH transmissions) to the base station over the TRP 107-2. In some such implementations, i the RRC reconfiguration message does not include the field or IE, the UE 102 does not initiate a random access procedure and transmits UL transmissions to the base station over the TRP 107-2. In further implementations, the UE 102 refrains from transmitting UL transmissions to the base station over the TRP 107-2 in response to receiving the field or IE. In some such cases, the UE 102 does not transmit a random access preamble to the base station 104 via the TRP 107-2 until receiving a PDCCH order from the base station (e.g., events 558, 560, 559, 561).

The blocks 548, 550, 552, 554, and 556 are collectively referred to in FIG. 5A as a TRP configuration procedure 596A.

In some implementations, after receiving the RRC reconfiguration message at event 538, after performing the CSI resource configuration and CSI reporting procedure 594, or after performing the TRP configuration procedure 596A with the base station 104, the UE 102 receives 562, 564 an RS from the base station 104 via the TRP 107-2. Depending on the implementation, the RS is configured in the CSI resource configuration of event 538, and the events 562, 564 occur after receiving the RRC reconfiguration message at event 538, during or after the CSI resource configuration and CSI reporting procedure 594, or during or after the TRP configuration procedure 596A. After performing the TRP configuration procedure 596A with the base station 104, the UE 102 initiates 598 a random access procedure. In response to initiating the random access procedure, the UE 102 transmits 566, 568 a second random access preamble on a time/frequency resource and a random access channel (RACH) occasion to the base station 104 via the TRP 107-2. In response to the second random access preamble, the base station 104 transmits 570, 572 a second random access response to the UE 102 via the TRP 107-2. The base station 104 includes a second preamble ID and a second TA command in the second random access response. The second preamble ID identifies the second random access preamble, and the second TA command includes a second TA value. The UE applies the second TA value and determines or maintains 574 an uplink synchronized with the TRP 107-2 after (e.g., in response to) applying the second TA value. The UE 102 applies the second TA value to transmit UL transmissions (e.g., PUCCH transmissions, PUSCH transmissions, and/or SRS transmissions) until the UE 102 receives a new or different TA value from base station 104 that updates the second TA value. In some implementations, the UE 102 starts a second TAT to maintain or manage UL synchronization status with the TRP 107-2 or base station 104 after or upon receiving the second TA command. In some implementations, the base station 104 includes a UL grant (e.g., an RAR grant) in the second random access response, and the UE 102 transmits a UL MAC PDU to the base station 104 via the TRP 107-2 in accordance with the UL grant. In cases where the random access procedure is a contention-based random access procedure, the UE 102 includes a C-RNTI of the UE 102 in the UL MAC PDU. The base station 104 identifies the UE 102 based on the C-RNTI. In response to the identification, the base station 104 generates a DCI and a CRC for the DCI, scrambles the CRC with the C-RNTI, and transmits the DCI and scrambled CRC on a PDCCH to the UE 102. In some implementations, the DCI includes n UL grant. Upon receiving the DCI and scrambled CRC on the PDCCH, the UE 102 determines that the content-based random access procedure 598 is performed successfully. In cases where the random access procedure 598 is a contention-free random access procedure, the UE 102 determines that the content-based random access procedure 598 is performed successfully in response to receiving the second random access response message.

In some implementations, the base station 104 starts a second TAT to maintain a second UL synchronization for UL and/or DL communication with the UE 102 via the TRP 107-2 after (e.g., in response to) transmitting the second TA command to the UE 102. In some implementations, the TRP 107-1 generates timing information for the second random access preamble received from the UE 102 and transmits the timing information to the base station 104. As an example, the timing information indicates a propagation delay or a propagation delay shift. Based on the timing information received from the TRP 107-2, the base station 104 determines the second TA value.

The blocks 566, 568, 570, 572, and 574 are collectively referred to in FIG. 5A as a random access procedure 598.

In some implementations, the UE 102 suspends communication (e.g., reception of DL channel/RS or transmission of UL channel/RS) with the base station 104 via the TRP 107-1 while performing the random access procedure 598. Depending on the implementation, the UE 102 does so if the UE 102 is not capable of simultaneously performing a random access procedure based on a UL beam or a RS (i.e., toward a TRP) and communicating UL and DL transmissions (i.c., not related to the random access procedure) based on another UL bcam or RS (i.e., toward another TRP). In other implementations, the UE 102 continues communication with the base station 104 via the TRP 107-2 while performing the random access procedure 598. After successfully completing 598 the random access procedure, the UE performs 576 DL and UL communications with the base station via TRP 107-1 and TRP 107-2 in accordance with the first TA value and second TA value, respectively.

In some implementations, the base station 104 and UE 102 use a HARQ entity (e.g., as depicted in FIGS. 4A, 4B, or 4C) to perform UL communication with the base station 104 via the TRP 107-1 and TRP 107-2 at event 576. In some cases (e.g., with the exemplary HARQ entity of FIG. 4B), the UL configuration parameters of events 548, 550 include HARQ configuration parameters. The HARQ configuration parameters configure a first set of HARQ processes IDs and a second set of HARQ processes IDs. In some cases, the first set of HARQ processes IDs and the second set of HARQ processes IDs are for the TRP 107-1 and TRP 107-2, respectively. The first set of HARQ processes IDs and second set of HARQ processes IDs identify a first set of HARQ processes of the HARQ entity and a second set of HARQ processes of the HARQ entity, respectively. In some implementations, none of the first set of HARQ processes IDs and second set of HARQ processes IDs are identical. In other implementations, some of the first set of HARQ processes IDs and second set of HARQ processes IDs are identical and others are different.

In some implementations, the base station 104 transmits, to the UE 102, one or more MAC CEs or DCIs to change or update one or more HARQ process IDs in the first set of HARQ processes IDs. In some further implementations, the base station 104 transmits, to the UE 102, one or more MAC CEs or DCIs to change or update one or more HARQ process IDs in the second set of HARQ processes IDs. In some alternative implementations, the base station 104 does not configure the first set of HARQ processes IDs and second set of HARQ processes IDs in the UL configuration parameters. In some implementations, the base station 104 determines the first set of HARQ processes IDs and second set of HARQ processes IDs for mTRP operation based on a pre-configuration. In further implementations, the first set of HARQ processes IDs and second set of HARQ processes IDs are specified sets (e.g., as specified in a 3GPP specification). In yet further implementations, the base station 104 determines the first set of HARQ processes IDs and second set of HARQ processes IDs based on a rule.

In some implementations, when the base station 104 determines to schedule the UE 102 to transmit a UL transmission to the TRP 107-1, the base station 104 selects a HARQ process ID from the first set of HARQ processes IDs and transmits a DCI, including a UL grant, and the selected HARQ process ID to the UE 102. The UE 102 uses a HARQ process identified by the selected HARQ process ID and transmits a UL transmission to the base station 104 using the HARQ process and UL grant. Similarly, when the base station 104 determines to schedule the UE 102 to transmit a UL transmission to the TRP 107-2, the base station 104 selects a HARQ process ID from the second set of HARQ processes IDs and transmits a DCI, including a UL grant, and the selected HARQ process ID to the UE 102. The UE 102 uses a HARQ process identified by the selected HARQ process ID and transmits a UL transmission to the base station 104 using the HARQ process and UL grant.

In some implementations, after receiving the RRC reconfiguration complete message at event 554, the base station 104 transmits 558, 560 a PDCCH order to the UE 102 via the TRP 107-2 to cause the UE 102 to initiate the random access procedure 598 with the base station 104 via the TRP 107-2. In some implementations, the PDCCH order includes an RS index and a random access preamble index. Alternatively, the base station 104 transmits the PDCCH order to the UE 102 via the TRP 107-1. In response to the PDCCH order, the UE 102 transmits the random access preamble to the base station 104 via the TRP 107-2 at event 566. In some implementations, the random access preamble index includes a value of the second preamble ID identifying the second random access preamble. Thus, the UE 102 determines the second random access preamble in accordance with the random access preamble index. In other implementations, the random access preamble index includes a value indicating or instructing the UE 102 to determine a random access preamble. Thus, the UE 102 determines the second random access preamble by (randomly) selecting it from the random access preambles configured in the system information.

In some implementations, the PDCCH order is a DCI. The base station 104 generates the DCI and a CRC for the DCI, scrambles the CRC with the C-RNTI, and transmits the DCI and scrambled CRC to the TRP 107-2 (e.g., via a fiber connection). In turn, the TRP 107-2 transmits the DCI and scrambled CRC on a PDCCH to the UE 102. In some implementations, the base station 104 transmits a first packet including the DCI and scrambled CRC to the TRP 107-2. In some implementations, the base station 104 transmits, to the TRP 107-2, control information configuring or indicating time and/or frequency resources for the PDCCH. In some implementations, the time and/or frequency resources include subcarriers, resource elements, or physical resource block(s). The TRP 107-2 transmits the DCI and scrambled CRC on the time and/or frequency resource in accordance with the control information. In some implementations, the base station 104 includes the control information in the first packet. In other implementations, the base station 104 transmits, to the TRP 107-2, a second packet including the control information, instead of the first packet. In other implementations, the base station 104 does not transmit control information for the DCI and scrambled CRC to the TRP 107-2. In such implementations, the TRP 107-2 determines time and/or frequency resources for the PDCCH and transmits the DCI and scrambled CRC on the time and/or frequency resources.

In some implementations, the RS index (e.g., SSB index) identifies one of the SSB(s). In some such implementations, the base station 104 determines or decodes the SSB index indicated in the CSI report(s). In further implementations, the base station 104 determines or decodes the SSB index based on a radio resource (e.g., PUCCH resource) where the base station 104 receives one of the CSI report(s) for the SSB. In some such implementations, the base station 104 configures a different radio resource for the UE 102 to transmit a CSI report for each of the SSB(s). In some examples, the base station 104 includes, in the RRC reconfiguration message of event 536, a configuration configuring a different radio resource (e.g., PUCCH resource) for the UE 102 to transmit a CSI report for each of the SSB(s). In some implementations, the UE 102 determines a time/frequency resource and/or a RACH occasion, based on the SSB (e.g., indicated in the RS index) and the random access configuration parameters received in the system information, and transmits the second random access preamble on the time/frequency resource and/or RACH occasion. In other implementations, the UE 102 determines a time/frequency resource and/or a RACH occasion, based on the SSB (e.g., indicated in the RS index) and the random access configuration parameters received in the RRC reconfiguration message of event 550, and transmits the second random access preamble on the time/frequency resource and/or RACH occasion.

In other implementations, the RS index (e.g., CSI-RS index) identifies one of the CSI-RS(s). In some implementations, the base station 104 determines or decodes the CSI-RS index indicated in the CSI report(s). In further implementations, the base station 104 determines or decodes the CSI-RS index based on a radio resource (e.g., PUCCH resource) where the base station 104 receives the CSI report(s) for the CSI-RS. In some such implementations, the base station 104 configures a different radio resource for the UE 102 to transmit a CSI report for each of the CSI-RS(s). In some examples, the base station 104 includes, in the RRC reconfiguration message of event 536, a configuration configuring a different radio resource (e.g., PUCCH resource) for the UE 102 to transmit a CSI report for each of the CSI-RS(s). In some implementations, the UE 102 determines a time/frequency resource and/or a RACH occasion, based on the CSI-RS (e.g., indicated in the RS index) and the random access configuration parameters in the RRC reconfiguration message that the UE 102 receives at event 550. The UE 102 transmits the second random access preamble on the time/frequency resource and/or RACH occasion. In some implementations, the random access configuration parameters indicate one or more associations between CSI-RS(s), and RACH occasion(s) and/or time/frequency resource(s).

In some implementations, the UE 102 determines transmission characteristics (e.g., spatial transmission filters/parameters) based on or by referring to the RS index in the PDCCH order and transmits the second random access preamble to the TRP 107-2 using the determined transmission characteristics. In some examples, the UE 102 uses reception characteristics for receiving 564 the RS identified by the RS index to derive the transmission characteristics. In some implementations, the transmission characteristics include phase, power, and/or transmission precoder. In some implementations, the UE 102 further uses the DL and/or UL configuration parameters of event 550 to determine the transmission characteristics. In further implementations, the UE 102 uses configuration parameters in the system information of event 510 to determine the transmission characteristics. In some implementations, the UE 102 determines transmission characteristics (e.g., spatial transmission filters/parameters) not based on or not referring to the RS index in the PDCCH order and transmits the second random access preamble to the TRP 107-2 using the determined transmission characteristics.

In some implementations, the UE 102 initiates 598 the random access procedure, in response to the random access configuration parameters received at event 550 and after receiving the RS at event 564. In such implementations, the base station 104 does not transmit the PDCCH order to cause the UE 102 to perform the random access procedure 598.

In some implementations, the RRC reconfiguration message of event 550 includes configuration parameters (e.g., for a PDCCH configuration, search space configuration, and/or control resource set (CORESET) configuration) for the UE 102 to receive DL transmissions from the TRP 107-2. In some implementations, the UE 102 receives the second random access response in accordance with the configuration parameters. In other implementations, the system information of event 510 includes configuration parameters for the UE 102 to receive a random access response from the TRP 107-2. In such implementations, the UE 102 receives the second random access response in accordance with the configuration parameters. In some implementations, the UE 102 uses reception characteristics for receiving 564 the RS to receive the second random access response from the TRP 107-2.

Although the TRP 107-2 is used in the scenario 500A, the above description can be applied to a scenario where the TRP 107-3 is used instead of the TRP 107-2. In such a scenario, after successfully completing a random access procedure with the base station via the TRP 107-3 and cell 125, similar to the procedure 598, the UE performs DL and UL communications with the base station via TRP 107-1 and TRP 107-3 in accordance with the first TA value and second TA value, respectively.

In some scenarios or implementations, the base station 104 transmits, to the UE 102 via the TRP 107-1 or TRP 107-2, a third TA command including a first new TA value to update the first TA value. In some implementations, the third TA command is a MAC control element (CE). The UE 102 applies the first new TA value for the first UL synchronization and restarts the first TAT of the UE 102 in response to receiving the third TA command. The base station 104 restarts the first TAT of the base station 104 in response to transmitting the third TA command. In some scenarios or implementations, the base station 104 transmits, to the UE 102 via the TRP 107-1 or TRP 107-2, a fourth TA command including a second new TA value to update the second TA value. In some implementations, the fourth TA command is a MAC CE. The UE 102 applies the second new TA value for the second UL synchronization and restarts the second TAT in response to receiving the fourth TA command. In some scenarios or implementations, the base station 104 transmits, to the UE 102 via the TRP 107-1 or TRP 107-2, a single TA command including the first new TA value and the second new TA value to update the first TA value and second TA value, respectively. In some implementations, the single TA command is a new or existing MAC control element (CE) (e.g., as defined in 3GPP specification 38.321 V17.1.0).

In some implementations, the TRP 107-1 generates timing information based on UL transmission(s) received from the UE 102 and transmits the timing information to the base station 104. In some examples, the timing information indicates a propagation delay or a propagation delay shift. Based on the timing information received from the TRP 107-1, the base station 104 determines whether to update the first TA value. In some implementations, if the propagation delay or the propagation delay shift is larger than or equal to a first threshold, the base station 104 determines to update the first TA value. Otherwise, if the propagation delay or the propagation delay shift is smaller than a second threshold, the base station 104 determines not to update the first TA value. In some implementations, if the base station 104 determines to update the first TA value, the base station 104 generates the first new TA value. In some implementations, the TRP 107-2 generates timing information based on UL transmission(s) received from the UE 102 and transmits the timing information to the base station 104. In some examples, the timing information indicates a propagation delay or a propagation delay shift. Based on the timing information received from the TRP 107-2, the base station 104 determines whether to update the second TA value. In some implementations, if the propagation delay or the propagation delay shift is larger than or equal to a third threshold, the base station 104 determines to update the second TA value. Otherwise, if the propagation delay or the propagation delay shift is smaller than a fourth threshold, the base station 104 determines not to update the first TA value. In some implementations, if the base station 104 determines to update the second TA valuc, the base station 104 generates the second new TA valuc. Depending on the implementation, the first, second, third, and fourth thresholds are the same or different.

Turning to FIG. 5B, a scenario 500B is similar to the scenario 500A, with differences described below. In the scenario 500B, the base station 104 transmits 549, 551, to the UE 102 via the TRP 107-1, an RRC reconfiguration message that includes the DL configuration parameters for DL communication with the base station 104 via the TRP 107-2. In some implementations, the base station 104 includes, in the RRC reconfiguration message, UL configuration parameters for UL communication with the base station 104 via the TRP 107-1 (e.g., to configure or enable DL communication with the base station 104 via the TRP 107-2). In some implementations, the base station 104 includes the DL configuration parameters in a CellGroupConfig IE and includes the CellGroupConfig IE in the RRC reconfiguration message. In some implementations, the base station 104 includes the DL configuration parameters in a BWP-DownlinkDedicated IE and includes the BWP-DownlinkDedicated IE in the RRC reconfiguration message. The RRC reconfiguration message of events 549, 551 is similar to the RRC reconfiguration message of events 548, 550, except that the base station 104 excludes or refrains from including, in the RRC reconfiguration message of events 549, 551, UL configuration parameters for UL communication with the base station 104 via the TRP 107-2. Instead, the base station 104 transmits 578, 580, to the UE 102 via the TRP 107-1, another RRC reconfiguration message that includes the UL configuration parameters for UL communication with the base station 104 via the TRP 107-2. In response, the UE 102 transmits 582, 584 an RRC reconfiguration complete message to the base station 104 via the TRP 107-1. In some implementations, the base station 104 includes the UL configuration parameters in a CellGroupConfig IE and includes the CellGroupConfig IE in the RRC reconfiguration message of events 578, 580. In some implementations, the base station 104 includes the UL configuration parameters in a BWP-UplinkDedicated IE and includes the BWP-UplinkDedicated IE in the RRC reconfiguration message.

The blocks 549, 551, 552, 554, 556, 578, 580, 582, and 584 are collectively referred to in FIG. 5B as a TRP configuration procedure 596B. After receiving the RRC reconfiguration message at event 538, performing the CSI resource configuration and CSI reporting procedure 594, or performing TRP configuration procedure 596B with the base station 104, the UE 102 receives 562, 564 the RS from the base station 104 via the TRP 107-2. After performing the TRP configuration procedure 596A with the base station 104, the UE 102 performs 598 the random access procedure with the base station 104 via the TRP 107-2.

Referring next to FIG. 5C, a scenario 500C is similar to the scenarios 500A and 500B with differences described below.

After transmitting 549, 550 the RRC reconfiguration message or receiving 552, 554 the RRC reconfiguration complete message, the base station 104 transmits 579, 581, to the UE 102 via the TRP 107-2, another RRC reconfiguration message that includes the UL configuration parameters for UL communication with the base station 104 via the TRP 107-2. The RRC rcconfiguration message of events 579, 581 arc similar to the RRC reconfiguration message of events 578, 580, except that the base station 104 transmits 579, 581 the RRC reconfiguration to the UE 102 via the TRP 107-2 instead of the TRP 107-1.

The blocks 549, 551, 552, 554, 556, 579, 581, 582, and 584 are collectively referred to in FIG. 5C as a TRP configuration procedure 596C.

Referring next to FIG. 5D, a scenario 500D is similar to the scenarios 500A, 500B, and 500C with differences described below.

After the UE 102 performs the TRP configuration procedure 596A, 596B or 596C with the base station 104, the UE 102 initiates 599 a random access procedure. In response to the initiation, the UE 102 transmits 566, 568 the second random access preamble to the base station 104 via TRP 107-2. In response, the base station 104 transmits 571, 573 the second random access response to the UE 102 via the TRP 107-1 instead of the TRP 107-2.

Referring next to FIG. 5E, a scenario 500E is similar to the scenarios 500A, 500B, 500C, and 500D with differences described below.

In some implementations, after receiving the RRC reconfiguration complete message at event 554, the base station 104 transmits 559, 561 a PDCCH order to the UE 102 via the TRP 107-1 to cause the UE 102 to initiate the random access procedure 598 or 599 with the base station 104 via the TRP 107-2, similar to the events 558, 560.

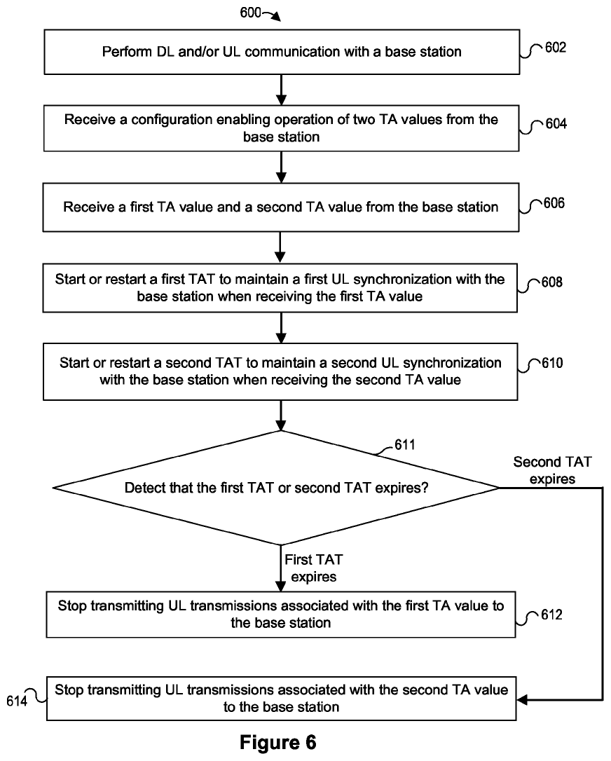

FIGS. 6-14 are flow diagrams depicting example methods that a UE (e.g., the UE 102) can implement to enable multiple TA value operations under a multiple-TRP scenario. FIGS. 6-14 illustrate some methods in which the UE determines actions upon expiry of one of multiple TAT and maintains multiple TA values. In some implementations, he first TRP and second TRP described below are the TRP 107-1 and TRP 107-2, for example. In another example, the first TRP and second TRP described below are the TRP 107-1 and TRP 107-3.

Some general descriptions are given below, which can be applied for the following flow diagrams and/or embodiments.

In some implementations, the UE performs DL reception from and/or UL transmission to a first TRP (e.g., one of TRP 107-1, TRP 107-2, TRP 107-3, TRP 108-1, and/or TRP 108-2). In some such implementations, the UE performs DL reception from and/or UL transmission to a second TRP (e.g., one of TRP 107-1, TRP 107-2, TRP 107-3, TRP 108-1, and/or TRP 108-2). In some implementations, the first TRP is located in the serving cell. In further implementations, the second TRP is located in the serving cell. Alternatively, the second TRP is located in a neighboring cell. In some implementations, the second TRP is located in a neighboring cell or a non-serving cell, where the neighboring cell or non-serving cell is a cell with a PCI different from that of the serving cell.

In some implementations, each TRP (e.g., TRP 107-1, TRP 107-2, TRP 107-3, TRP 108-1, and/or TRP 108-2) is associated with or identified by a TRP identifier. In some implementations, a base station (e.g., the base station 104 or 106) includes a TRP identifier in UL configuration(s) that the base station transmits to a UE (e.g., the UE 102) for UL transmission(s) via a TRP identified by the TRP identifier. In some implementations, the UL configuration(s) include DCI transmitted on a PDCCH, and/or PUSCH configuration, PUCCH configuration and/or SRS configuration included in an RRC message (e.g., RRC reconfiguration message or an RRC resume message) that the base station transmits to the UE. In some implementations, the UL transmission(s) include PUSCH transmission(s), PUCCH transmission(s), and/or SRS transmission(s). In some implementations, the base station includes a TRP identifier in DL configuration(s) that the base station transmits to the UE 102 for DL transmission(s) via a TRP identified by the TRP identifier. In some implementations, the DL configuration(s) include DCI transmitted on a PDCCH, and/or CSI resource configuration, PDSCH configuration(s) and/or PDCCH configuration(s) included in an RRC message (c.g., RRC reconfiguration message or an RRC resume message) that the base station transmits to the UE. In some implementations, the DL transmission(s) include CSI-RS transmission(s), SSB transmission(s), PDSCH transmission(s), and/or PDCCH transmission(s).

In other implementations, the base station does not transmit a TRP identifier to the UE and uses an implicit indication to indicate a TRP to the UE. In some implementations, the implicit indication is one of the following configuration parameters: a CORESETPoolIndex, a value or value candidate of a CORESETPoolIndex, a dataScramblingIdentityPDSCH, a dataScrambling IdentityPDSCH2-r16, or a PUCCH-ResourceGroup-r16. In such implementations, the UE derives a TRP (identifier) from the implicit indication. In some implementations, the base station transmits an RRC message (e.g., RRC reconfiguration message or an RRC resume message), including the configuration parameter, to the UE.

In some implementations, the base station configures or indicates to the UE a first TRP identifier. In some implementations, the UE derives a first TRP identifier and/or identifier value. In some implementations, the base station configures or indicates to the UE a second TRP identifier and/or identifier value. In some implementations, the UE derives a second TRP identifier and/or identifier value.

In some cases, the UE maintains a plurality of TA values. In some such implementations, the UE maintains a plurality of TA values, where all of the plurality of TA values are indicated or signaled to the UE. In further such implementations, the UE maintains a plurality of TA values, where all of the plurality of TA values are derived by the UE. In some implementations, the UE maintains a plurality of TA values, where at least one of some TA values are indicated or signaled to the UE and at least one of the remaining TA values are derived by the UE. In further implementations, the UE maintains or operates the plurality of TA values in a serving cell. In some implementations, the base station indicates or configures the UE respective ID for the plurality of TA values. In some implementations, the UE derives respective ID for the plurality of TA values. In some such implementations, each of the plurality of TA values has an individual ID. In some such cases, the UE maintains the plurality of TA values for or in a serving cell.

In some cases, the base station configures or activates, for the UE, a first set of serving cells. In some cases, the base station configures or activates, for the UE, a second set of serving cells. In some implementations, the first set of serving cells has the same serving cells elements as those of the second set of serving cells. In some implementations, the first set of serving cells has different serving cells elements from those of the second set of serving cells.

In some cases, the base station configures or activates, for the UE, a third set of serving cells. In some implementations, the third set of serving cells at least comprise the first set of serving cells. In further implementations, the third set of serving cells at least comprise the second set of serving cells. In some implementations, the third set of serving cells at least comprise the first set of serving cells and the second set of serving cells. In some implementations, the third set of serving cells are the union of the first set of serving cells and the second set of serving cells. In some implementations, the third set of serving cells are the intersection of the first set of serving cells and the second set of serving cells.

In some cases, the UE may maintain a first TA value, which is among the plurality of TA values. In some cases, the UE may maintain a second TA value, which is among the plurality of TA values. In some implementations, the first TA value may be associated with the first TRP. In some implementations, the second TA value may be associated with the second TRP.

Depending on the implementation, the first TA value: (i) applies for or is associated with the first set of serving cells, (ii) applies for or is associated with the first TRP, (iii) applies for or is associated with UL channel/RS transmission transmitted to the first TRP, and/or (iv) applies for or is associated with UL channel/RS transmission related to the first TRP identifier and/or identifier value.

Depending on the implementation, the second TA value: (i) applies for or is associated with the second set of serving cells, (ii) applies for or is associated with the second TRP, (iii) applies for or is associated with UL channel/RS transmission transmitted to the second TRP, and/or (iv) applies for or is associated with UL channel/RS transmission related to the second TRP identifier and/or identifier value.

In some cases, the base station indicates or configures, for the UE, an ID of the first TA value. In some cases, the UE derives an ID of the first TA value. In some cases, the base station indicates or configures, for the UE, an ID of the second TA value. In some cases, the UE derives an ID of the second TA value.

In some cases, the base station configures or indicates, for the UE, one or more TA group(s). In some implementations, one TA group (TAG) includes or is associated with one or more serving cell and/or indices. In some implementations, each serving cell included in or associated with the same TAG uses or is operated with the one or more TA values. In some implementations, one TAG includes or is associated with one or more TA values. In some implementations, the UE is indicated to or configured, or the UE derives, respective ID(s) for the one or more TA group(s). In some such implementations, each TAG has an individual ID.

In some cases, the base station configures or indicates, for the UE, a first TAG. In some implementations, the first TAG is among the one or more TA group(s). In some implementations, the first TA value or the ID of the first TA value is associated with or included in the first TAG.

In some cases, the base station configures or indicates, for the UE, a second TAG. In some implementations, the second TAG is among the one or more TA group(s). In some implementations, the second TA value or the ID of the second TA value is associated with or included in the second TAG.

In some cases, the first TA value and second TA value are associated with or included in the same TAG.

In some implementations, the first TAG is associated with the first TRP or the first TRP identifier and/or identifier value. In some implementations, the first TAG includes or is associated with the first set of serving cells. In some implementations, the first set of serving cells is configured with or associated with the first TRP or the first TRP identifier and/or identifier value. In some implementations, in each serving cell of the first set of serving cells, at least one CORESET is configured with or associated with CORESETPoolIndex #0.

In some implementations, the first TAG includes or is associated with one or more TA values, where the one or more TA values: (i) applies for or is associated with the first set of serving cells, (ii) applies for or is associated with the first TRP, (iii) applies for or is associated with UL channel/RS transmission related to the first TRP or the first TRP identifier and/or identifier value, and/or (iv) applies for or is associated with the third set of serving cells.

In some implementations, the second TAG is associated with the second TRP or the second TRP identifier and/or identifier value. In some implementations, the second TAG includes or is associated with a second set of serving cells. In some implementations, the second set of serving cells are configured with or associated with the second TRP or the second TRP identifier and/or identifier value. In some implementations, in each serving cell of the second set of serving cells, at least one CORESET is configured with or associated with CORESETPoolIndex #1.

In some implementations, the second TAG includes or is associated with one or more TA values, where the one or more TA values: (i) applies for or is associated with the second set of serving cells, (ii) applies for or is associated with the second TRP, (iii) applies for or is associated with UL channel/RS transmission related to the second TRP or the second TRP identifier and/or identifier value, and/or (iv) applies for or is associated with the third set of serving cells.

In some cases, the base station indicates or configures, for the UE, an ID of the first TAG. In some cases, the UE derives an ID of the first TAG. In some cases, the base station indicates or configures, for the UE, an ID of the second TAG. In some cases, the UE derives an ID of the second TAG.

In some cases, the base station indicates or configures, for the UE, a third TAG. In some implementations, the third TAG is among the one or more TA group(s). In some implementations, the UE has indicated to or configured, or the UE may derive, an ID of the third TAG.

In some implementations, the third TAG is associated with the first TRP or the first TRP identifier and/or identifier value. In some implementations, the third TAG is associated with the second TRP or the second TRP identifier and/or identifier value. In some implementations, the third TAG includes or is associated with the third set of serving cells.

In some implementations, the third TAG includes or is associated with one or more TA values. In some implementations, the third TAG includes or is associated with one or more TA values, where the one or more TA values include the first TA value and/or the second TA value.

In some implementations, if the base station indicates or configures, for the UE, the third TAG, the UE determines to expect at least one of the following: (i) all serving cells included in or associated with the third TAG are configured with a multiple-TRP (M-TRP) mode by the base station (e.g., the M-TRP mode is a single-DCI (S-DCI) M-TRP mode or multiple-DCI (M-DCI) M-TRP mode), (ii) all serving cells included in or associated with the third TAG are configured with CORESETPoolIndex by the base station, and/or (iii) all serving cells included in or associated with the third TAG are configured, by the base station, with or associated with the first TRP identifier and/or identifier value and the second TRP identifier and/or identifier value.

In some implementations, if the base station configures the third TAG for the UE, the base station performs one or some of the following: (i) configuring all serving cells included in or associated with the third TAG with an M-TRP mode, (e.g., the M-TRP mode is an S-DCI M-TRP mode or M-DCI M-TRP mode), (ii) configuring all serving cells included in or associated with the third TAG with CORESETPoolIndex, and/or (iii) configuring or associating all serving cells included in or associated with the third TAG with the first TRP identifier and/or identifier value and the second TRP identifier and/or value.

In some cases, the base station configures or indicates, for the UE, one or more primary TAGS (PTAGs). In some implementations, the base station configures or indicates, for the UE, two PTAGs. In some cases, the base station configures or indicates, for the UE, one or more secondary TAGs (STAGs).

In some cases, the first TAG is a PTAG. In some implementations, the first set of serving cells comprises a primary cell (PCell) or primary secondary cell (PSCell). In some implementations, the first TAG is a STAG. In some implementations, the first set of serving cells does not comprise a PCell or PSCell.

In some cases, the second TAG is a PTAG. In some implementations, the second set of serving cells comprises a PCell or PSCell. In some implementations, the second TAG is a STAG. In some implementations, the second set of serving cells does not comprise a PCell or PSCell.

In some cases, the third TAG is a PTAG. In some implementations, the third set of serving cells comprises a PCell or PSCell. In some implementations, the third TAG is a STAG. In some implementations, the third set of serving cells does not comprise a PCell or PSCell.

In some cases, the base station configures or indicates, for the UE, one or more Time Alignment Timer(s) (TAT(s)). In some implementations, the one or more TAT(s) are configured or indicated for an active BWP or in a serving cell. In some implementations, the base station configures or indicates, for the UE, a first TAT in the active BWP or in the serving cell. In some implementations, the base station configures or indicates, for the UE, a second TAT in the active BWP or in the serving cell. In some implementations, the UE maintains the first TAT. In some implementations, the UE maintains the second TAT. In some implementations, the base station similarly maintains the first TAT and/or second TAT.

In some implementations, the first TAT is associated with the first TAG. In further implementations, the first TAT is associated with or applied to the first set of serving cells. In some implementations, the second TAT is associated with the second TAG. In further implementations, the second TAT is associated with or applied to the second set of serving cells.

In some implementations, the base station configures or indicates, for the UE, an ID of the first TAT. In further implementations, the UE derives an ID of the first TAT. In some implementations, the base station configures or indicates, for the UE, an ID of the second TAT. In further implementations, the UE derives an ID of the second TAT.

In some cases, the base station configures or indicates, for the UE, a third TAT in the active BWP or in the serving cell. In some implementations, the third TAT is associated with or applied to the third set of serving cells. In some implementations, the UE maintains the third TAT. In some implementations, the base station similarly maintains the third TAT. In some implementations, the base station configures or indicates, for the UE, an ID of the third TAT. In further implementations, the UE derives an ID of the third TAT.

In some cases, the first TA value and the second TA value belong to or are associated with a same TAG (e.g., the third TAG). In some implementations, the ID of the first TA value and the ID of the second TA value are included in a same TAG (e.g., the third TAG). In some cases, the first TA value and the second TA value belong to or are associated with different TAGs (e.g., the first TAG and the second TAG). In some implementations, the ID of the first TA value and the ID of the second TA value are included in different TAGs (e.g., the first TAG and the second TAG).

In some cases, whether the first TA value is expired and whether the second TA value is expired are controlled by or associated with a same TAT (e.g., the third TAT). In further cases, whether the first TA value is expired and whether the second TA value is expired are controlled by or associated with different TATs (e.g., the first TAT and the second TAT).

In some cases, whether the first TAG is uplink time aligned and whether the second TAG is uplink time aligned are controlled by or associated with a same TAT (e.g., the third TAT). In further cases, whether the first TAG is uplink time aligned and whether the second TAG is uplink time aligned are controlled by or associated with different TATs (e.g., the first TAT and the second TAT).

In some cases, whether the first set of serving cells is uplink time aligned and whether the second set of serving cells is uplink time aligned are controlled by or associated with a same TAT (e.g., the third TAT). In further cases, whether the first set of serving cells is uplink time aligned and whether the second set of serving cells is uplink time aligned are controlled by or associated with different TATs (e.g., the first TAT and the second TAT).

In some implementations, the base station configures, for the UE, a first TAG and a second TAG for UL transmissions to the first TRP and second TRP, respectively. In some implementations, the base station transmits, to the UE, a first RRC message and a second RRC message including a first TAG configuration and a second TAG configuration to configure the first TAG and second TAG, respectively. In some implementations, the first TAG configuration and second TAG configuration include a first TAG ID and a second TAG ID to identify the first TAG and second TAG, respectively. In some implementations, the first TAG configuration and second TAG configuration include a timer value of/for the first TAT and a timer value of/for the second TAT for the first TAG and second TAG, respectively. In some implementations, the first RRC message and second RRC message are the same RRC message (e.g., the same instance) or different RRC messages (e.g., different instances or different types of RRC messages). In some implementations, the first and second RRC messages are RRC setup, RRC reconfiguration, and/or RRC resume messages. The UE associates the first TA value and second TA value with the first TAG and second TAG, respectively. In some implementations, the first TAG is associated with the first TRP or the first TRP identifier and/or identifier value. In some implementations, the first TAG is associated with a particular serving cell operated by the first TRP and configured for the UE. In some implementations, the first TAG is associated with additional serving cell(s) operated by the first TRP and configured for the UE. In some implementations, the base station indicates or configures the association(s) in the first RRC message. In some implementations, the second TAG is associated with the second TRP or the second TRP identifier and/or identifier value. In some implementations, the second TAG is associated with the particular serving cell or non-serving cell, and the base station indicates or configures the association in the second RRC message.

In other implementations, the base station configures, for the UE, a single TAG (e.g., a third TAG) for UL transmissions to the first TRP and second TRP. In some implementations, the base station transmits, to the UE, a first RRC message (e.g., RRC setup, RRC reconfiguration and/or RRC resume message), including a single TAG configuration to configure the TAG. In some implementations, the TAG configuration includes a single TAG ID to identify the TAG. In some implementations, the TAG configuration includes a timer value of/for the first TAT and a timer value of/for the second. In further implementations, the TAG configuration includes a timer value of/for the first TAT, and the base station transmits a second RRC message (e.g., RRC setup, RRC reconfiguration, and/or RRC resume message), including a timer value of the second TAT. The UE associates the first TA value and second TA value with the TAG. In some implementations, the TAG is associated with (i) the first TRP or the first TRP identifier and/or identifier value and (ii) the second TRP or the second TRP identifier. In some implementations, the TAG is associated with a particular serving cell operated by the first TRP and configured for the UE. In some implementations, the TAG is associated with additional serving cell(s) operated by the first TRP and configured for the UE. In some implementations, the base station indicates or configures the association(s) in the first RRC message. In some implementations, the TAG is associated with the second TRP or the second TRP identifier and/or identifier value. In some implementations, the TAG is associated with the particular serving cell or non-serving cell, and the base station indicates or configures the association in the second RRC message.

In some implementations, the base station configures that the particular serving cell is associated with the first TRP or the first TRP identifier and/or identifier value. In some implementations, the base station configures a first control resource set (CORESET) associated with the particular serving cell or first TRP. In further implementations, the base station configures CORESETPoolIndex #0 to identify the first CORESET. In some implementations, the base station transmits, to the UE, a third RRC message (e.g., an RRC setup message, an RRC reconfiguration message, or an RRC resume message) configuring the first CORESET and/or including the CORESETPoolIndex #0. Thus, the UE monitors a PDCCH on the first CORESET to receive DCIs from the base station, which implies that the UE monitors a PDCCH or receives DCIs via the first TRP from the base station (i.e., from the first TRP). In some such cases, the UE determines that CORESETPoolIndex #0 indicates a particular TRP (i.e., the first TRP) of the base station.

In some implementations, the base station configures a particular serving cell to be associated with the second TRP or the second TRP identifier and/or identifier value. In other implementation, the second TAG is associated with a non-serving cell, and the base station indicates or configures the association in the second RRC message. In some implementations, the base station configures the non-serving cell associated with the second TRP or the second TRP identifier and/or identifier value. In some implementations, the base station configures a second CORESET to be associated with the particular serving cell, non-serving cell, or second TRP. In further implementations, the base station configures CORESETPoolIndex #1 to identify the second CORESET. In some implementations, the base station transmits, to the UE, a third RRC message (e.g., an RRC setup message, an RRC reconfiguration message, or an RRC resume message), configuring the second CORESET and/or including the CORESETPoolIndex #1. Thus, the UE monitors a PDCCH on the second CORESET to receive DCIs from the base station, which implies that the UE monitors a PDCCH or receives DCIs via the second TRP from the base station (i.e., from the second TRP). In some such implementations, the UE determines that CORESETPoolIndex #1 indicates a particular TRP (i.e., the second TRP).

In some implementations, the base station configures a first ID for identifying the first TA value for the UE, in addition to the TAG ID(s) described above. In some implementations, the base station includes the first ID in the RRC message described above. In further implementations, the base station includes the first ID in the first TA command. In other implementations, the UE derives or determines the first ID and associates the first ID with the first TA value. Similarly, the base station configures a second ID for identifying the second TA value for the UE, in addition to the TAG ID(s) described above. In some implementations, the base station includes the second ID in the RRC message described above. In further implementations, the base station includes the second ID in the second TA command. In other implementations, the UE derives or determines the second ID and associates the second ID with the second TA value.

More generally, in some implementations, the base station configures or indicates, to the UE, a first index for or associated with the first TRP. In some implementations, the UE derives or determines the first index. In some implementations, the first index is one of: (i) the first TRP identifier and/or identifier value, (ii) an ID of the first TAG, (iii) an ID of the first TA value, and/or (iv) an ID of the first TAT.

More generally, in further implementations, the base station configures or indicates, to the UE, a second index for/associated with the second TRP. In some implementations, the UE derives the second index. In some implementations, the second index is one of: (i) the second TRP identifier and/or identifier value, (ii) an ID of the second TAG, (iii) an ID of the second TA value, and/or (iv) an ID of the second TAT.

In some cases, the first TAT is started or restarted by the UE or the base station in response to at least one of the following: (i) the UE receives a Timing Advance Command MAC CE where the Timing Advance Command MAC CE indicates or updates timing adjustment related information for the first TA value or the first TAG or the first TAT; (ii) the UE receives a Timing Advance Command in an RAR response or in a MAC payload for an RAR response, where: (a) in some implementations, the RAR response or the Timing Advance Command is transmitted by or associated with the first TRP, (b) in some implementations, the RAR response or the Timing Advance Command is associated with the first index, and/or (c) in some implementations, the RAR response or the Timing Advance Command indicates that the RAR response and/or Timing Advance Command is for the first TRP; and/or (iii) the UE receives an Absolute Timing Advance Command in a response to a MSGA transmission including C-RNTI MAC CE where: (a) in some implementations, the response to the MSGA or the Absolute Timing Advance Command is transmitted by or associated with the first TRP, (b) in some implementations, the response to the MSGA or the Absolute Timing Advance Command is associated with the first index, and/or (c) in some implementations, the response to the MSGA or the Absolute Timing Advance Command indicates that the response is for the first TRP.

In some cases, the second TAT is started or restarted in response to at least one of the following: (i) the UE receives a Timing Advance Command MAC CE, where, in some implementations, the Timing Advance Command MAC CE indicates or updates timing adjustment related information for the second TA value, the second TAG, or the second TAT; (ii) the UE receives a Timing Advance Command in an RAR response or in a MAC payload for an RAR response where: (a) in some implementations, the RAR response or the Timing Advance Command may be transmitted by or associated with the second TRP, (b) in some implementations, the RAR response or the Timing Advance Command is associated with the second index, and/or (c) in some implementations, the RAR response or the Timing Advance Command indicates that the RAR response or the Timing Advance Command is for the second TRP; and/or (iii) the UE receives an Absolute Timing Advance Command in a response to an MSGA transmission including C-RNTI MAC CE, where: (a) in some implementations, the response to the MSGA or the Absolute Timing Advance Command is transmitted by or associated with the second TRP, (b) in some implementations, the response to the MSGA or the Absolute Timing Advance Command is associated with the second index, and/or (iii) in some implementations, the response to the MSGA or the Absolute Timing Advance Command indicates that the response is for the second TRP.

In some cases, the third TAT is started or restarted in response to at least one of the following: (i) the UE receives a Timing Advance Command MAC CE, where, in some implementations, the Timing Advance Command MAC CE indicates or updates timing adjustment related information for at least one of the following: (a) the first TA value, the first TAG, or the first TAT; (b) the second TA value, the second TAG, or the second TAT; and/or (c) the third TA value, the third TAG, or the third TAT; (ii) the UE receives a Timing Advance Command in an RAR response or in a MAC payload for an RAR response where: (a) in some implementations, the RAR response or the Timing Advance Command is transmitted by or associated with the first TRP and/or the second TRP, (b) in some implementations, the RAR response or the Timing Advance Command is associated with the first index and/or the second index, and/or (c) in some implementations, the RAR response or the Timing Advance Command indicates that the RAR response or Timing Advance Command is for the first TRP and/or the second TRP; and/or (iii) the UE receives an Absolute Timing Advance Command in a response to an MSGA transmission including C-RNTI MAC CE where: (a) in some implementations, the response to the MSGA or the Absolute Timing Advance Command is transmitted by or associated with the first TRP and/or the second TRP, (b) in some implementations, the response to the MSGA or the Absolute Timing Advance Command is associated with the first index and/or the second index, and/or (c) in some implementations, the response to the MSGA or the Absolute Timing Advance Command indicates that the response is for the first TRP and/or the second TRP.

Turning first to FIG. 6, a UE (e.g., the UE 102) implements an example method 600 to perform operation of multiple TA values under a multiple-TRP scenario.

The method 600 begins at block 602, where the UE performs DL and/or UL communication with a base station (e.g., events 504, 506, 508, 510, 512, 514, 516, 518, 590, 522, 524, 526, 528, 532, 534, 592, 536, 538, 540, 542, 544, 546, 594, 549, 551, 552, 554, 556, 562, 564). At block 604, the UE receives a configuration enabling operation of two TA values from the base station (e.g., events 548, 550, 596A, 578, 580, 596B, 579, 581, 596C) . At block 606, the UE receives a first TA value and a second TA value from the base station (e.g., events 516, 518, 570, 571, 572, 573, 590, 598, 599). At block 608, the UE starts or restarts a first TAT to maintain a first UL synchronization with the base station when (e.g., upon, after, or in response to) receiving the first TA value. At block 610, the UE starts or restarts a second TAT to maintain a second UL synchronization with the base station when receiving the second TA value. At block 611, the UE detects whether the first TAT or second TAT expires. If the UE detects that the first TAT expires, the flow proceeds to block 612. At block 612, the UE stops transmitting UL transmissions associated with the first TA value to the base station. If the UE detects that the second TAT expires, the flow proceeds to block 614. At block 614, the UE stops transmitting UL transmissions associated with the second TA value to the base station.

When the first TAT expires, and the UE stops transmitting to the first TRP, the UE can continue UL transmissions associated with the second TAT to the second TRP. Conversely, when the second TAT expires, and the UE stops transmitting to the second TRP, the UE can continue UL transmission associated with the second TAT to the first TRP. For example, in some implementations, the UE reports the loss of synchronization (e.g., TAT expiration) with the first TRP to the base station, and the base station stops scheduling transmissions to the first TRP but continues scheduling transmissions to the second TRP.

In some implementations, the UE maintains a first UL synchronization and a second UL synchronization with the base station based on the first TA value and second TA value, respectively. In some implementations, the UE applies the first TA value and second TA value to first UL transmissions and second UL transmissions with the base station on a serving cell, respectively. In other implementations, the UE applies the first TA value and second TA value to transmit first UL transmissions and second UL transmissions on a serving cell and a non-serving cell with the base station, respectively.

In some implementations, the UE receives the first TA value in a first random access response, a first MAC CE, or a first MAC PDU from the base station. In some implementations, the UE receives the second TA value in a second random access response, a second MAC CE, or a second MAC PDU from the base station. In some implementations, the first MAC CE and second MAC CE are the same MAC CE. In further implementations, the first MAC CE and the second MAC CE are different MAC CEs with the same MAC CE format or different MAC CE formats. In some implementations, the first MAC PDU and second MAC PDU are the same MAC PDU. In further implementations, the first MAC PDU and the second MAC PDU are different MAC PDUs.

More detailed descriptions of elements of the method 600 are described herein, particularly with regard to the general description above. For example, in some implementations: (i) the first TA value and the second TA value shown at block 606 are described in the description of the first TA value and the second TA value described with regard to the general description above, and (ii) the first TAT and the second TAT shown at block 608 and 610 are described in the description of the first TAT and the second TAT described with regard to the general description above.

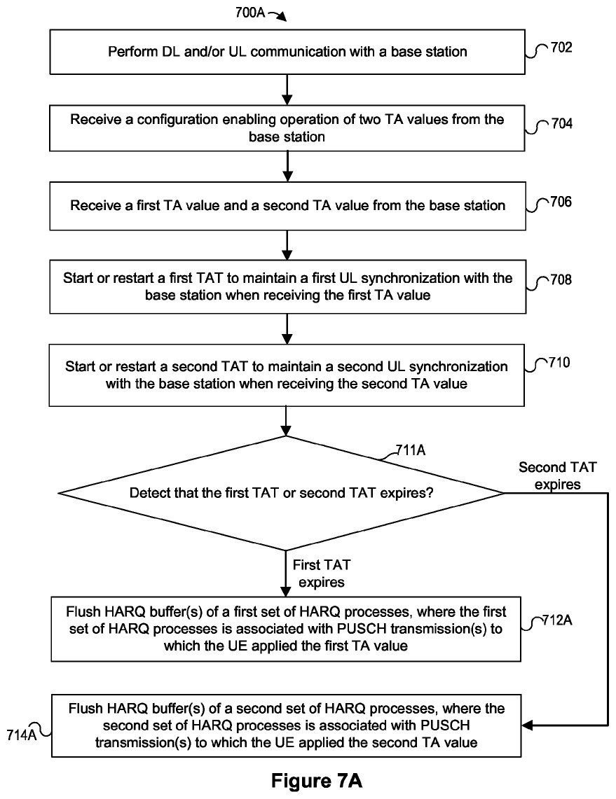

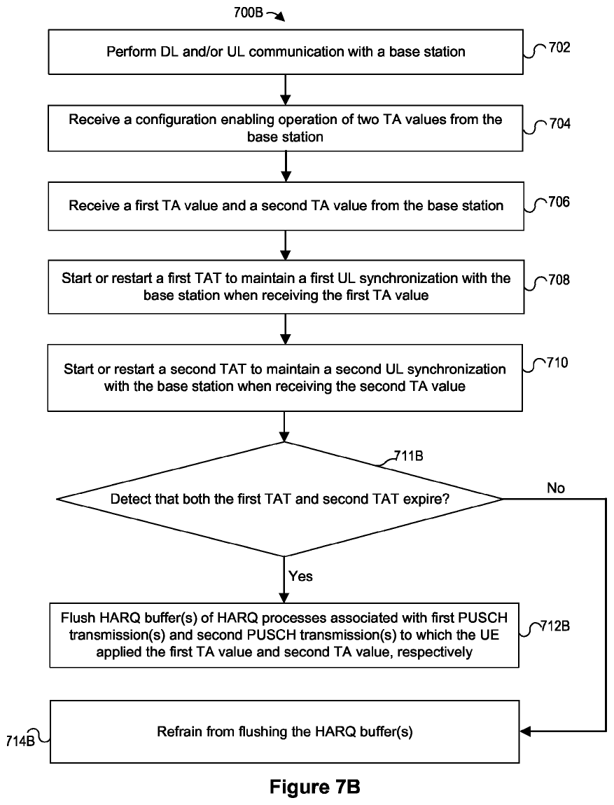

Turning next to FIG. 7A, a UE (e.g., the UE 102) implements an example method 700A to perform operation of multiple TA values under a multiple-TRP scenario.

The method 700A begins at block 702. Blocks 702, 704, 706, 708, 710, and 711A are similar to blocks 602, 604, 606, 608, 610, and 611. If the UE detects that the first TAT expires, the flow proceeds to block 712A. At block 712A, the UE flushes HARQ buffer(s) of a first set of HARQ processes, where the first set of HARQ processes is associated with PUSCH transmission(s) to which the UE applied the first TA value. If the UE detects that the second TAT expires, the flow proceeds to block 714A. At block 714A, the UE flushes HARQ buffer(s) of a second set of HARQ processes, where the second set of HARQ processes is associated with PUSCH transmission(s) to which the UE applied the second TA value.

FIG. 7B illustrates an example method 700B similar to the scenario 700A illustrated in FIG. 7A, except that the method 700B includes blocks 711B, 712B, and 714B, as described below.

At block 711B, the UE detects whether both the first TAT and second TAT expire. If the UE detects that both the first TAT and second TAT expire, the flow proceeds to block 712B. At block 712B, the UE flushes HARQ buffer(s) of HARQ processes associated with first PUSCH transmission(s) and second PUSCH transmission(s) to which the UE applied the first TA value and second TA value, respectively. If the UE does not detect that both the first TAT and second TAT expire, the flow proceeds to block 714B. At block 714B, the UE refrains from flushing the HARQ buffer(s).

Similar to the method 600, more detailed descriptions of elements of the method 700 are generally detailed above.

In some cases, the UE is signaled by or configured with one or more HARQ process in the serving cell. In some implementations, the UE is signaled by or configured with one or more HARQ processes in each of the one or more serving cells. For example, the UE is signaled by or configured with at most 16 HARQ processes in the serving cell. As another example, the UE is signaled by or configured with at most 16 HARQ processes in each of the one or more serving cells, such that each of the serving cells is signaled by or configured with at most 16 HARQ processes.

In some cases, the UE is signaled by or configured with a first set of HARQ processes. In some cases, the UE derives a first set of HARQ processes. In some implementations, the UE is signaled by or configured with a first set of HARQ processes in each of the first set of serving cells. In some implementations, the UE derives a first set of HARQ processes in each of the first set of serving cells. In some implementations, some elements or ID numbers in each first set of HARQ processes in each of the first set of serving cells are different. In further implementations, some elements or ID numbers in each first set of HARQ processes in each of the first set of serving cells are the same. For example, when the first set of serving cells include serving cell #0 and serving cell #1, the first set of HARQ processes in serving cell #0 for some such examples are: HARQ process #1, #2, and #5. However, the first set of HARQ processes in serving cell #1 are: HARQ processes #1, #5, and #9.

In some cases, the UE is signaled by or configured with a second set of HARQ processes. In some cases, the UE may derive a second set of HARQ processes. In some implementations, the UE is signaled by or configured with a second set of HARQ processes in each of the second set of serving cells. In some implementations, the UE derives a second set of HARQ processes in each of the second set of serving cells. In some implementations, some elements or ID numbers in each second set of HARQ processes in each of the second set of serving cells are different. In some implementations, some elements or ID numbers in each second set of HARQ processes in each of the second set of serving cells are the same. For example, when the second set of serving cells include serving cell #0 and serving cell #1, the second set of HARQ processes in serving cell #0 is: HARQ processes #3, #6, and #11.

However, the second set of HARQ processes in serving cell #1 are: HARQ processes #2, #4, and #8.

In some implementations, at least in one serving cell, the elements in the first set of HARQ processes are orthogonal to those in the second set of HARQ processes. In some implementations, at least in one serving cell, each value of HARQ process IDs in the first set of HARQ processes are different from the values in the second set of HARQ processes. In some implementations, at least in one serving cell, no value of HARQ process ID in the first set of HARQ processes is the same as the values in the second set of HARQ processes. For example, when the first set of serving cells and the second set of serving cells both include serving cell #0 and serving cell #1, the first set of HARQ processes in serving cell #0 is: HARQ processes #1, #2, and #5. However, the first set of HARQ processes in serving cell #1 is: HARQ processes #1, #5, and #9. The second set of HARQ processes in serving cell #0 is: HARQ process #3, #6, and #11. However, the second set of HARQ processes in serving cell #1 is: HARQ processes #2, #4, and #8.

In some cases, the first set of HARQ processes is associated with one of the candidate value(s) of the TRP identifier. In some implementations, the first set of HARQ processes is associated with one of the candidate value(s) of CORESETPoolIndex. In some implementations, the first set of HARQ processes is associated with CORESETPoolIndex #0. In further implementations, the first set of HARQ processes is associated with CORESETPoolIndex #1.

In some cases, the second set of HARQ processes is associated with one of the candidate value(s) of the TRP identifier. In some implementations, the second set of HARQ processes is associated with one of the candidate valuc(s) of CORESETPoolIndex. In some implementations, the second set of HARQ processes is associated with CORESETPoolIndex #1. In further implementations, the second set of HARQ processes is associated with CORESETPoolIndex #0.

In some cases, the first set of HARQ processes is associated with the first index. In further cases, the second set of HARQ processes is associated with the second index.

In some cases, for a HARQ process in the first set of HARQ processes, the HARQ process includes at least one of the following attributes: (i) in some implementations, the HARQ process is used to transmit a UL transmission, where the UL transmission is transmitted by spatial transmission filters/parameters derived from a spatial relation, a UL/joint TCI state, or a source RS, which are associated with or include the first TA value; (ii) in some implementations, the HARQ process is used to transmit a UL transmission, where the UL transmission is transmitted using the first TA value; and/or (iii) in some implementations, the HARQ process is used to transmit a UL transmission, where the UL transmission is associated with or includes the first TA value.

In some cases, for a HARQ process in the second set of HARQ processes, the HARQ process includes at least one of the following attributes: (i) the HARQ process is used to transmit a UL transmission, where the UL transmission is transmitted by spatial transmission filters/parameters derived from a spatial relation, a UL/joint TCI state, or a source RS, which are associated with or include the second TA value; (ii) the HARQ process is used to transmit a UL transmission, where the UL transmission is transmitted using the second TA value; and/or (iii) the HARQ process is used to transmit a UL transmission, where the transmission is associated with or includes the second TA value.

In some cases, the base station signals or configures, for the UE, one HARQ entity in a serving cell. In some implementations, the base station signals or configures, for the UE, only one HARQ entity in a serving cell. In some implementations, the base station signals or configures, for the UE, one HARQ entity in each of the first set of serving cells. In some implementations, the base station signals or configures, for the UE, one HARQ entity in each of the second set of serving cells. In some implementations, the base station signals or configures, for the UE, one HARQ entity in at least one serving cell among the first set of serving cells. In some implementations, the base station signals or configures, for the UE, one HARQ entity in at least one serving cell among the second set of serving cells. In some implementations, one or more of each of the first set of serving cells is signaled or configured with one HARQ entity by the base station. In some implementations, one or more of each of the second set of serving cells is signaled or configured with one HARQ entity by the base station.

In some implementations, the first set of HARQ processes may be included or belong to a HARQ entity in a first serving cell. In some implementations, the second set of HARQ processes may be included or belong to the HARQ entity in the first serving cell.

In some implementations, the first serving cell is associated with or included in the first set of serving cells. In some implementations, the first serving cell is associated with or included in the second set of serving cells. In some implementations, the first serving cell is associated with or included in the third set of serving cells.

In some cases, the base station signals or configures, for the UE, more than one HARQ entity in a serving cell. In some implementations, the base station signals or configures, for the UE, more than one HARQ entity in each of the first set of serving cells. In some implementations, the base station signals or configures, for the UE, more than one HARQ entity in each of the second set of serving cells. In some implementations, the base station signals or configures, for the UE, more than one HARQ entity in at least one serving cell among the first set of serving cells. In some implementations, the base station signals or configures, for the UE, more than one HARQ entity in at least one serving cell among the second set of serving cells. In some implementations, one or more of each of the first set of serving cells is signaled by or configured with more than one HARQ entity. In some implementations, one or more of each of the second set of serving cells is signaled by or configured with more than one HARQ entity.

In some implementations, the base station signals or configures, for the UE, a first HARQ entity in a second serving cell. In some implementations, the base station signals or configures, for the UE, a second HARQ entity in the second serving cell.

In some implementations, the second serving cell is associated with or included in the first set of serving cells. In some implementations, the second serving cell is associated with or included in the second set of serving cells. In some implementations, the second serving cell is associated with or included in the third set of serving cells.

In some implementations, the first HARQ entity is associated with the first TRP or the first TRP identifier and/or identifier value. In some implementations, the first HARQ entity includes the first TRP identifier and/or identifier value. For example, the first HARQ entity is associated with or includes CORESETPoolIndex #0. In some implementations, the first HARQ entity comprises or is associated with the first set of HARQ processes.

In some implementations, the second HARQ entity is associated with the second TRP or the second TRP identifier and/or identifier value. In some implementations, the second HARQ entity includes the second TRP identifier and/or identifier value. For example, the second HARQ entity is associated with or includes CORESETPoolIndex #1. In some implementations, the second HARQ entity comprises or is associated with the second set of HARQ processes.

In some implementations, the base station indicates or signals elements or HARQ process ID included in the first set of HARQ processes. In some implementations, the base station indicates or signals elements or HARQ process ID included in the first set of HARQ processes by at least one of DCI signaling, MAC-CE, or RRC signaling. In some implementations, the base station indicates or signals elements or HARQ process ID included in the first set of HARQ processes via a bitmap. In some implementations, the base station indicates or signals elements or HARQ process ID included in the first set of HARQ processes. In some implementations, the base station indicates or signals elements or HARQ process ID included in the first set of HARQ processes by at least one of DCI signaling, MAC-CE, or RRC signaling. In some implementations, the base station indicates or signals elements or HARQ process ID included in the first set of HARQ processes by a bitmap.

In some implementations, the base station indicates or signals elements or HARQ process ID included in the second set of HARQ processes. In some implementations, the base station indicates or signals elements or HARQ process ID included in the second set of HARQ processes by at least one of DCI signaling, MAC-CE, or RRC signaling. In some implementations, the base station indicates or signals elements or HARQ process ID included in the second set of HARQ processes by a bitmap. In some implementations, the base station updates or changes elements or HARQ process ID included in the second set of HARQ processes. In some implementations, the base station updates or changes elements or HARQ process ID included in the second set of HARQ processes by at least one of DCI signaling, MAC-CE, or RRC signaling. In some implementations, the base station updates or changes elements or HARQ process ID included in the second set of HARQ processes by a bitmap.

In some cases, if a UL transmission (e.g., UL data) is related to the first TRP or the first TRP identifier and/or identifier value, the UL transmission is associated with or uses a HARQ process among the first set of HARQ processes.

In some cases, if a UL transmission (e.g., UL data) is related to the second TRP or the second TRP identifier and/or identifier value, the UL transmission is associated with or uses a HARQ process among the second set of HARQ processes.

In some cases, the UE performs at least one of the following actions in response to expiry of the first TAT: (i) flushing or clearing HARQ buffer(s) belonging to or associated with the first set of HARQ processes, where: (a) in some implementations, the UE performs the action when the UE does not support retransmission scheduled by PDCCH received in a different CORESETPoolIndex compared to the CORESETPoolIndex of the initial transmission (e.g., the UE is not expected to receive, for the same HARQ process ID, DCI from a different CORESETPoolIndex that schedules the retransmission); (b) in some implementations, the UE performs the action when the UE reports supportRetx-Diff-CoresetPool-Multi-DCI-TRP-r16; and/or (c) in some implementations, the action refers to flushing or clearing HARQ buffer(s) belonging to or associated with each of the first set of HARQ processes in the first set of serving cell; (ii) not flushing or clearing HARQ buffers belonging to or associated with the second set of HARQ processes; (iii) not flushing or clearing HARQ buffer(s) belonging to or associated with each of the second set of HARQ processes in the second set of serving cell; (iv) not flushing or clearing HARQ buffers belonging to or associated with HARQ process(es) other than the first set of HARQ processes in the first and/or the second serving cell; and/or (v) not flushing or clearing HARQ buffer(s) belonging to or associated with HARQ process(es) other than the first set of HARQ processes in the first set of serving cell and/or the second set of serving cell. In some such cases, the first TAG is a STAG. In some such cases, the first TA value belongs to or is associated with a STAG. In some such cases, the first TAT is associated with a STAG.

Alternatively, the UE performs at least one of the following actions in response to expiry of the first TAT: (i) flushing or clearing HARQ buffers belonging to or associated with the second set of HARQ processes, (ii) flushing or clearing HARQ buffer(s) belonging to or associated with each of the second set of HARQ processes in the second set of serving cells, (iii) flushing or clearing HARQ buffers belonging to or associated with HARQ process(es) other than the first set of HARQ processes in the first and/or the second serving cell, (iv) flushing or clearing HARQ buffer(s) belonging to or associated with HARQ process(es) other than the first set of HARQ processes in the first set of serving cells and/or the second set of serving cells, (v) flushing or clearing all HARQ buffers in the first and/or the second serving cell, (vi) flushing or clearing all HARQ buffers in the first set of serving cells and/or the second set of serving cells, (vii) flushing or clearing all HARQ buffers belonging to or associated with HARQ process(es) of data related to the first index in all serving cells, and/or (viii) flushing or clearing all HARQ buffers in all serving cells. In some such cases, the first TAG is a PTAG. In some such cases, the first TA value belongs to or is associated with a PTAG. In some such cases, the first TAT is associated with a PTAG.

In some cases, the UE performs at least one of the following actions in response to expiry of the second TAT: (i) flushing or clearing HARQ buffer(s) belonging to or associated with the second set of HARQ processes, where: (a) in some implementations, the UE performs the action when the UE does not support retransmission scheduled by PDCCH received in a different CORESETPoolIndex compared to the CORESETPoolIndex of the initial transmission, (e.g., the UE is not expected to receive, for the same HARQ process ID, DCI from a different CORESETPoolIndex that schedules the retransmission); (b) in some implementations, the UE performs the action when the UE reports supportRetx-Diff-CoresetPool-Multi-DCI-TRP-r16; and/or (c) in some implementations, the action refers to flushing or clearing HARQ buffer(s) belonging to or associated with each the second set of HARQ processes in the second set of serving cell; (ii) not flushing or clearing HARQ buffers belonging to or associated with the first set of HARQ processes; (iii) not flushing or clearing HARQ buffer(s) belonging to or associated with each the first set of HARQ processes in the first set of serving cells, (iv) not flushing or clearing HARQ buffers belonging to or associated with HARQ process(es) other than the second set of HARQ processes in the first and/or the second serving cell, and/or (v) not flushing or clearing HARQ buffer(s) belonging to or associated with HARQ process(es) other than the second set of HARQ processes in the first set of serving cells and/or the second set of serving cells. In some such cases, the second TAG is a STAG. In some such cases, the second TA value may belong to or be associated with a STAG. In some such cases, the second TAT is associated with a STAG.

Alternatively, the UE performs at least one of the following actions in response to expiry of the second TAT: (i) flushing or clearing HARQ buffers belonging to or associated with the first set of HARQ processes, (ii) flushing or clearing HARQ buffer(s) belonging to or associated with each of the first set of HARQ processes in the first set of serving cells, (iii) flushing or clearing HARQ buffers belonging to or associated with HARQ process(es) other than the second set of HARQ processes in the first and/or the second serving cell, (iv) flushing or clearing HARQ buffer(s) belonging to or associated with HARQ process(es) other than the second set of HARQ processes in the first set of serving cells and/or the second set of serving cells, (v) flushing or clearing all HARQ buffers in the first and/or the second serving cell, (vi) flushing or clearing all HARQ buffers in the first set of serving cells and/or the second set of serving cells, (vii) flushing or clearing all HARQ buffers belonging to or associated with HARQ process(es) of data related to the second TRP or the second TRP identifier and/or identifier value in all serving cells, and/or (viii) flushing or clearing all HARQ buffers in all serving cells. In some such cases, the second TAG is a PTAG. In some such cases, the second TA value belongs to or is associated with a PTAG. In some such cases, the second TAT is associated with a PTAG.

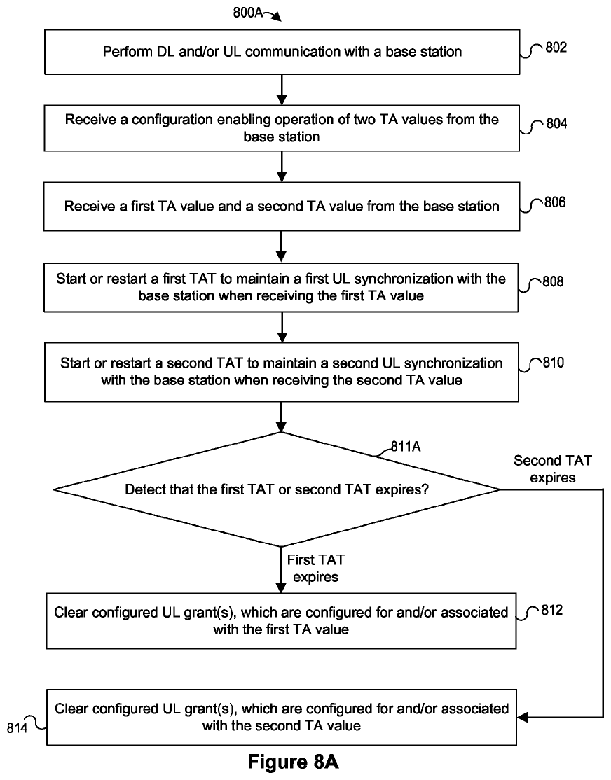

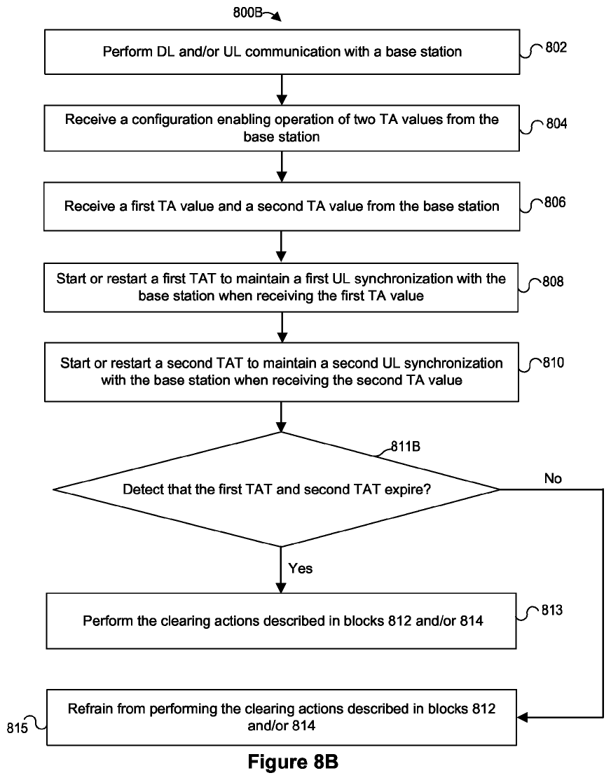

Turning next to FIG. 8A, a UE (e.g., the UE 102) implements an example method 800A to perform operation of multiple TA values under a multiple-TRP scenario.

The method 800A begins at block 802. Blocks 802, 804, 806, 808, 810, and 811A are similar to blocks 602, 604, 606, 608, 610, and 611. If the UE detects that the first TAT expires, the flow proceeds to block 812. At block 812, the UE clears configured UL grant(s) which are configured and/or associated with the first TA value. If the UE detects that the second TAT expires, the flow proceeds to block 814. At block 814, the UE clears configured UL grant(s) which are configured and/or associated with the second TA value.

FIG. 8B illustrates an example method 800B similar to the scenario 800A illustrated in FIG. 8A, except that the method 800B includes blocks 811B, 813, and 815.

At block 811B, the UE detects whether the first TAT and second TAT expire. If the UE detects that the first TAT and second TAT expire, the flow proceeds to block 813. At block 813, the UE performs the clearing actions described in blocks 812 and/or 814. If the UE does not detect that the first TAT and second TAT expire, the flow proceeds to block 815. At block 815, the UE refrains from performing the clearing actions described in blocks 812 and/or 814.

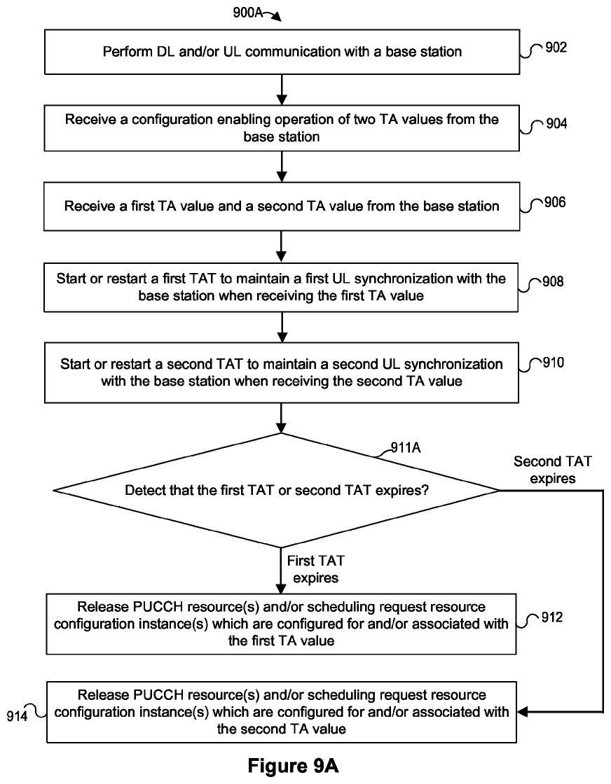

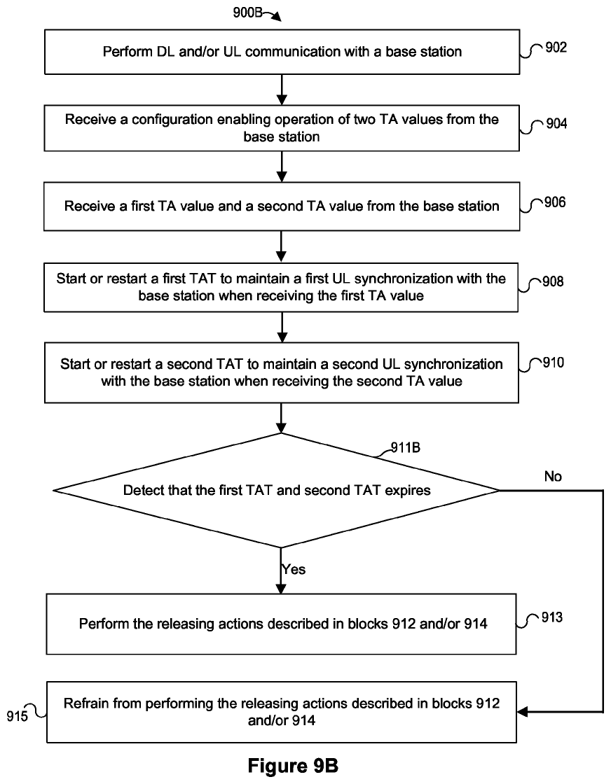

Turning next to FIG. 9A, a UE (e.g., the UE 102) implements an example method 900A to perform operation of multiple TA values under a multiple-TRP scenario.

The method 900A begins at block 902. Blocks 902, 904, 906, 908, 910, and 911A are similar to blocks 602, 604, 606, 608, 610, and 611. If the UE detects that the first TAT expires, the flow proceeds to block 912. At block 912, the UE releases PUCCH resource(s) and/or scheduling request resource configuration instance(s) which are configured and/or associated with the first TA value. If the UE detects that the second TAT expires, the flow proceeds to block 914. At block 914, the UE releases PUCCH resource(s) and/or scheduling request resource configuration instances(s) which are configured and/or with the second TA value.

FIG. 9B illustrates an example method 900B similar to the scenario 900A illustrated in FIG. 9A, except that the method 900B includes blocks 911B, 913, and 915.

At block 911B, the UE detects whether the first TAT and second TAT expire. If the UE detects that the first TAT and second TAT expire, the flow proceeds to block 913. At block 913, the UE performs the releasing actions described in blocks 912 and/or 914. If the UE does not detect that the first TAT and second TAT expire, the flow proceeds to block 915. At block 815, the UE refrains from performing the releasing actions described in blocks 912 and/or 914.

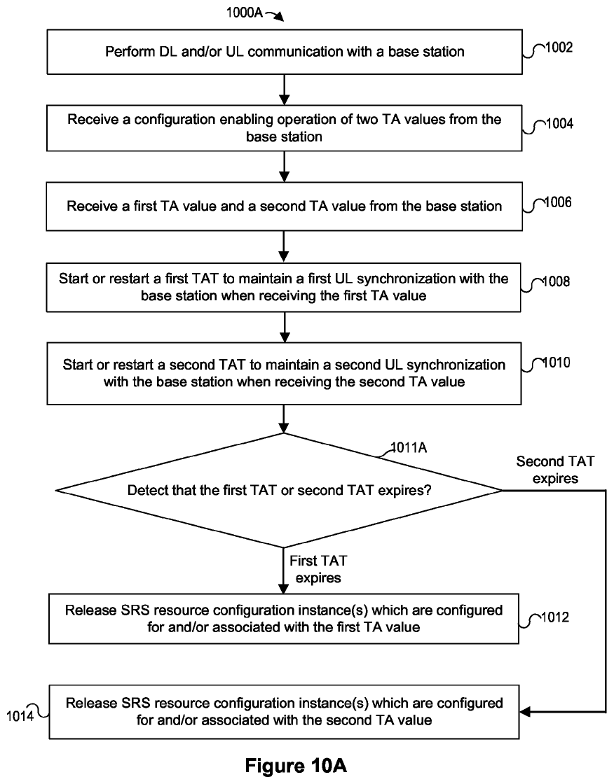

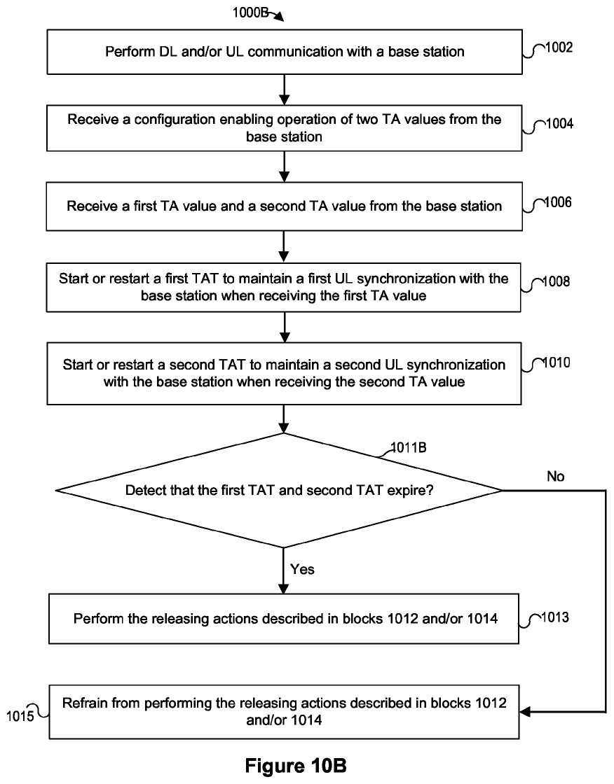

Turning next to FIG. 10A, a UE (e.g., the UE 102) implements an example method 1000A to perform operation of multiple TA values under a multiple-TRP scenario.

The method 1000A begins at block 1002. Blocks 1002, 1004, 1006, 1008, 1010, and 1011A are similar to blocks 602, 604, 606, 608, 610, and 611. If the UE detects that the first TAT expires, the flow proceeds to block 1012. At block 1012, the UE releases SRS resource configuration instances which are configured and/or associated with the first TA value. If the UE detects that the second TAT expires, the flow proceeds to block 1014. At block 1014, the UE releases SRS resource configuration instances, which are configured and/or associated with the second TA value.

FIG. 10B illustrates an example method 1000B similar to the scenario 1000A illustrated in FIG. 10A, except that the method 1000B includes blocks 1011B, 1013, and 1015.

At block 1011B, the UE detects whether the first TAT and second TAT expire. If the UE detects that the first TAT and second TAT expire, the flow proceeds to block 1013. At block 1013, the UE performs the releasing actions described in blocks 1012 and/or 1014. If the UE does not detect that the first TAT and second TAT expire, the flow proceeds to block 1015. At block 1015, the UE refrains from performing the releasing actions described in blocks 1012 and/or 1014.

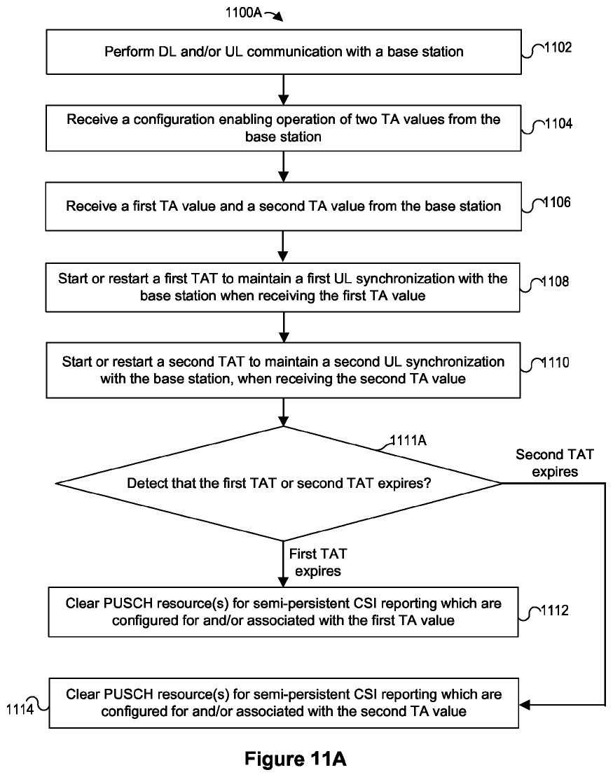

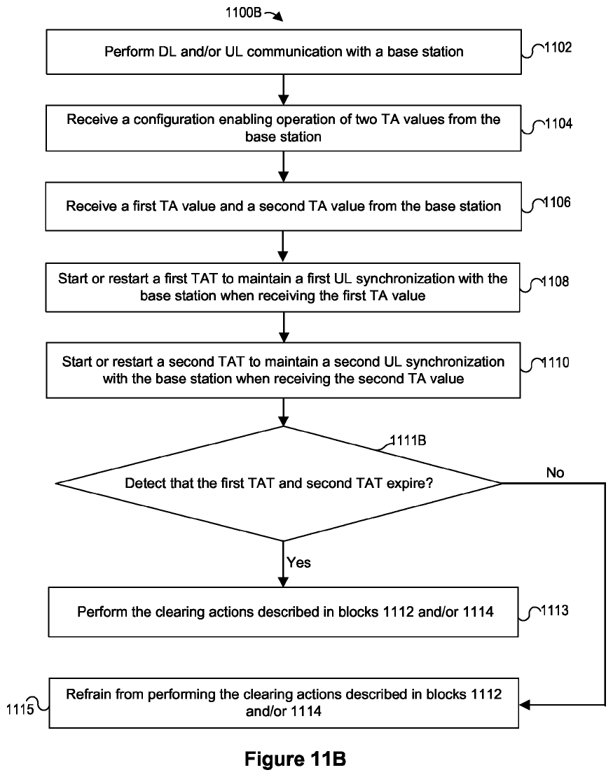

Turning next to FIG. 11A, a UE (e.g., the UE 102) implements an example method 1100A to perform operation of multiple TA values under a multiple-TRP scenario.

The method 1100A begins at block 1102. Blocks 1102, 1104, 1106, 1108, 1110, and 1111A are similar to blocks 602, 604, 606, 608, 610, and 611. If the UE detects that the first TAT expires, the flow proceeds to block 1112. At block 1112, the UE clears PUSCH resource(s) for semi-persistent CSI reporting, which are configured and/or associated with the first TA value. If the UE detects that the second TAT expires, the flow proceeds to block 1114. At block 1114, the UE clears PUSCH resource(s) for semi-persistent CSI reporting, which are configured and/or associated with the second TA value.

FIG. 11B illustrates an example method 1100B similar to the scenario 1100A illustrated in FIG. 11A, except that the method 1100B includes blocks 1111B, 1113, and 1115.

At block 1111B, the UE detects whether the first TAT and second TAT expire. If the UE detects that the first TAT and second TAT expire, the flow proceeds to block 1113. At block 1113, the UE performs the clearing actions described in blocks 1112 and/or 1114. If the UE does not detect that the first TAT and second TAT expire, the flow proceeds to block 1115. At block 1115, the UE refrains from performing the clearing actions described in blocks 1112 and/or 1114.

Similar to the method 600, more detailed descriptions of elements of the methods 800A-1100B are generally described above.

In some cases, the UE, in response to expiry of the first TAT, releases, clears, or suspends a configured resource or transmits an RRC notification to release a configured resource in the first set of serving cells, where the configured resource is associated with the first TA value or the first index. In some such cases, the first TAG is a STAG. In some such cases, the first TA value belongs to or is associated with a STAG. In some such cases, the first TAT is associated with a STAG.

In some cases, the UE, in response to expiry of the second TAT, releases, clears, or suspends a configured resource or transmits an RRC notification to release a configured resource in the second set of serving cells, where, in some implementations, the configured resource is associated with the second TA value or the second index. In some such cases, the second TAG is a STAG. In some such cases, the second TA value belongs to or is associated with a STAG. In some such cases, the second TAT is associated with a STAG.

In some cases, the configured resource is one of the following: (i) a PUCCH resource, (ii) an SRS resource, (iii) configured downlink assignments (e.g., DL SPS), (iv) configured uplink grants, and/or (v) a PUSCH resource, where the PUSCH resource is for semi-persistent CSI reporting.

In some cases, if the configured resource is associated with the first TA value, then the configured resource adheres to at least one of the following: (i) he configured resource is transmitted via the first TA value, (ii) the configured resource or a configuration for the configured resource includes the first TA value, (iii) a configuration for the configured resource includes the first index, (iv) the configured resource is transmitted by spatial transmission filters/parameters derived from a spatial relation (or a UL/joint TCI state or a reference signal) associated with or including the first TA value, and/or (v) the configured resource is received by spatial reception filters/parameters derived from a joint TCI state (or a TCI state, a QCL assumption, or a reference signal) associated with or including the first TA value.

In some cases, if the configured resource is associated with the second TA value, then the configured resource adheres to at least one of the following: (i) the configured resource is transmitted via the second TA value, (ii) the configured resource or a configuration for the configured resource includes the second TA value, (iii) a configuration for the configured resource includes the second index, (iv) the configured resource is transmitted by spatial transmission filters/parameters derived from a spatial relation (or a UL/joint TCI state or a reference signal) associated with or including the second TA value, and/or (v) the configured resource is received by spatial reception filters/parameters derived from a joint TCI state (or a TCI state, a QCL assumption, or a reference signal) associated with or including the second TA value.

In some cases, the UE performs at least one of the following actions in response to expiry of the first TAT: (i) releasing, clearing, or suspending the configured resource or transmitting an RRC notification to release, clear, or suspend the configured resource associated with the first TRP/TAG/TAT/TA value or the first index in all serving cells; and/or (ii) releasing, clearing, or suspending the configured resource or transmitting an RRC notification to release, clear, or suspend the configured resource in all serving cells. In some such cases, the first TAG is a PTAG. In some such cases, the first TA value belongs to or is associated with a PTAG. In some such cases, the first TAT is associated with a PTAG.

In some cases, the UE performs at least one of the following actions in response to expiry of the second TAT: (i) releasing, clearing, or suspending the configured resource or transmitting an RRC notification to release, clear, or suspend the configured resource associated with the second TRP/TAG/TAT/TA value or the second index in all serving cells; and/or (ii) releasing, clearing, or suspending the configured resource or transmitting an RRC notification to release, clear, or suspend the configured resource in all serving cells. In some such cases, the second TAG is a PTAG. In some such cases, the second TA value belongs to or is associated with a PTAG. In some such cases, the second TAT is associated with a PTAG.

In some cases, the UE, in response to expiry of the first TAT maintains, keeps, or otherwise stores the first TA value. In some such cases, the first TAG is a STAG. In some such cases, the first TA value belongs to or is associated with a STAG. In some such cases, the first TAT is associated with a STAG.

Alternatively, the UE performs at least one of the following actions in response to expiry of the first TAT: (i) maintaining, keeping, or otherwise storing all indicated or derived TA values associated with the first TRP/TAG/TAT/TA value or the first index across all TAGs; (ii) maintaining, keeping, or otherwise storing the second TA value; and/or (iii) maintaining, keeping, or otherwise storing all indicated or derived TA values across all TAGs. In some such cases, the first TAG is a PTAG. In some such cases, the first TA value belongs to or is associated with a PTAG. In some such cases, the first TAT is associated with a PTAG.

In some cases, the UE, in response to expiry of the second TAT, maintains, keeps, or stores the second TA value. In some such cases, the second TAG is a STAG. In some such cases, the second TA value belongs to or is associated with a STAG. In some such cases, the second TAT is associated with a STAG.

Alternatively, the UE performs at least one of the following actions in response to expiry of the second TAT: (i) maintaining, keeping, or storing all indicated or derived TA values associated with the second TRP/TAG/TAT/TA value or the second index across all TAGs; (ii) maintaining, keeping, or storing the first TA value; and/or (iii) maintaining, keeping, or storing all indicated or derived TA values across all TAGs. In some such cases, the second TAG may be a PTAG. In some such cases, the second TA value may belong to or be associated with a PTAG. In some such cases, the second TAT may be associated with a PTAG.

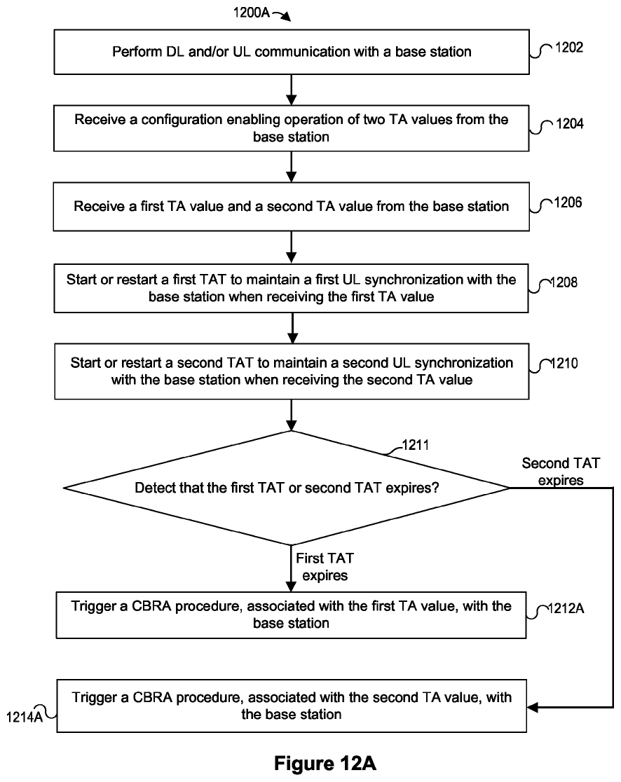

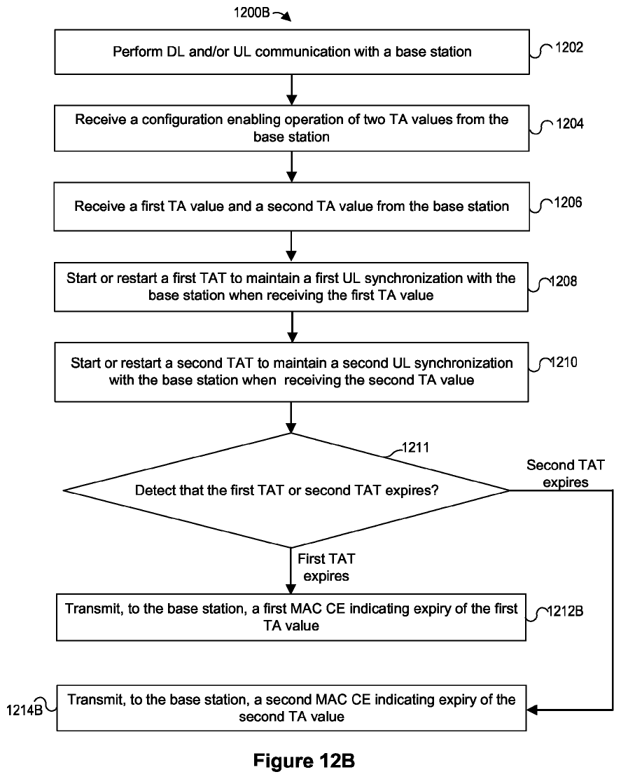

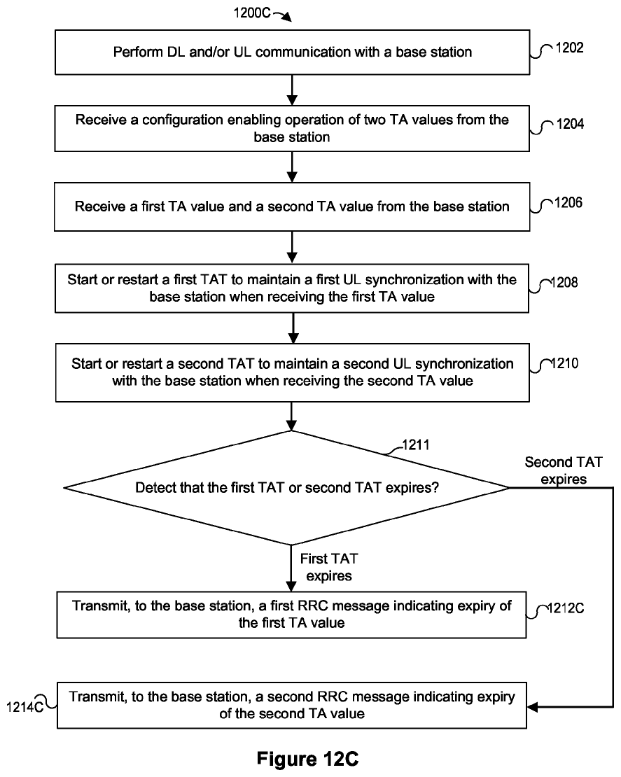

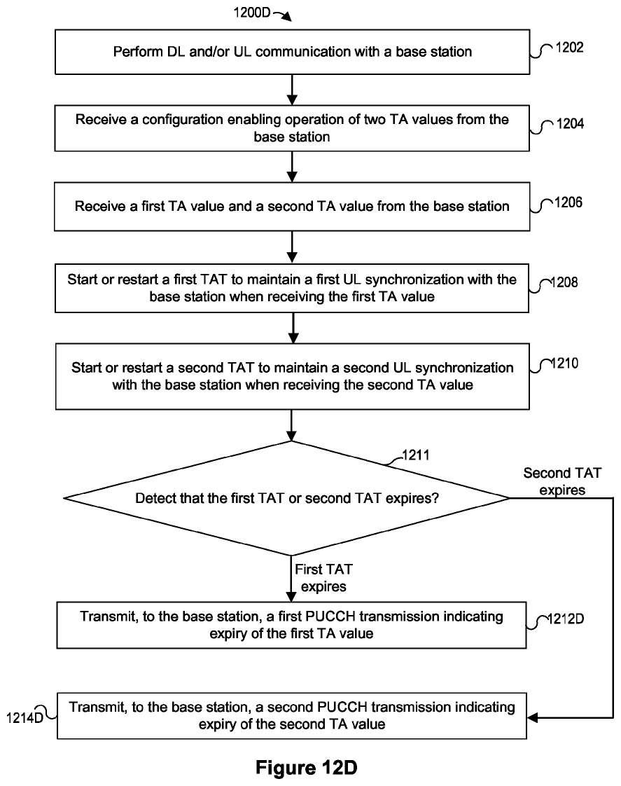

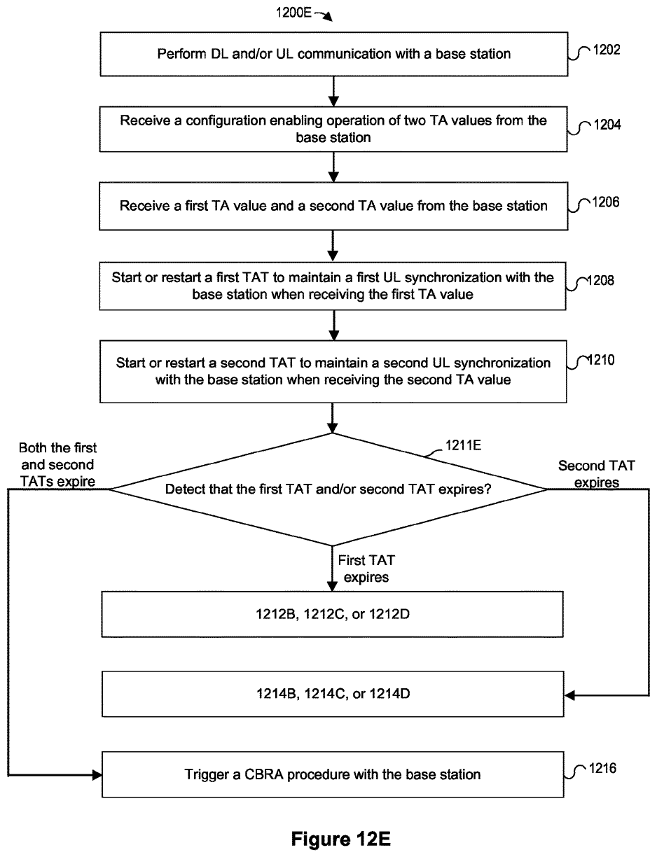

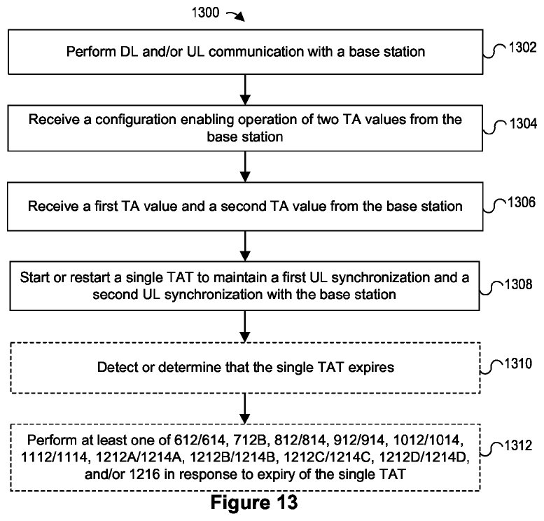

Turning next to FIG. 12A, a UE (e.g., the UE 102) implements an example method 1200A to perform operation of multiple TA values under a multiple-TRP scenario.

The method 1200A begins at block 1202. Blocks 1202, 1204, 1206, 1208, 1210, and 1211 are similar to blocks 602, 604, 606, 608, 610, and 611. If the UE detects that the first TAT expires, the flow proceeds to block 1212A. At block 1212A, the UE triggers a CBRA procedure, associated with the first TA value, with the base station. If the UE detects that the second TAT expires, the flow proceeds to block 1214A. At block 1214A, the UE triggers a CBRA procedure, associated with the second TA value, with the base station.

FIG. 12B illustrates an example method 1200B similar to the scenario 1200A illustrated in FIG. 12A, except that the method 1200B includes blocks 1212B and 1214B.

If the UE detects that the first TAT expires, the flow proceeds to block 1212B. At block 1212B, the UE transmits, to the base station, a first MAC CE indicating expiry of the first TA value. If the UE detects that the second TAT expires, the flow proceeds to block 1214B. At block 1214B, the UE transmits, to the base station, a second MAC CE indicating expiry of the second TA value.

In some implementations, the first MAC CE and second MAC CE have the same MAC CE format. In some implementations, the UE transmits a MAC PDU, including a subheader of the first MAC CE and the first MAC CE, to the base station at block 1212B. In some implementations, the UE transmits a MAC PDU, including a subheader of the second MAC CE and the second MAC CE, to the base station at block 1214B.

In some implementations, the UE includes, in the first MAC CE, an ID of the first TA value or an ID of a first TAG to which the first TA value is associated. In some implementations, the UE includes, in the second MAC CE, an ID of the second TA value or an ID of a second TAG to which the second TA value is associated.

FIG. 12C illustrates an example method 1200C similar to the scenario 1200A illustrated in FIG. 12A, except that the method 1200C includes blocks 1212C and 1214C.

If the UE detects that the first TAT expires, the flow proceeds to block 1212C. At block 1212C, the UE transmits, to the base station, a first RRC message indicating expiry of the first TA value. If the UE detects that the second TAT expires, the flow proceeds to block 1214C. At block 1214C, the UE transmits, to the base station, a second RRC message indicating expiry of the second TA value.

In some implementations, the first RRC message and second RRC message have the same RRC message format. For example, the first RRC message and second RRC message are UE assistance information messages (e.g., UEAssistanceInformation messages).

In some implementations, the UE includes, in the first RRC message, an ID of the first TA value or an ID of a first TAG to which the first TA value is associated. In some implementations, the UE includes, in the second RRC message, an ID of the second TA value or an ID of a second TAG to which the second TA value is associated.

FIG. 12D illustrates an example method 1200D similar to the scenario 1200A illustrated in FIG. 12A, except that the method 1200D includes blocks 1212D and 1214D.

If the UE detects that the first TAT expires, the flow proceeds to block 1212D. At block 1212D, the UE transmits, to the base station, a first PUCCH transmission indicating expiry of the first TA value. If the UE detects that the second TAT expires, the flow proceeds to block 1214D. At block 1214D, the UE transmits, to the base station, a second PUCCH transmission indicating expiry of the second TA value.

In some implementations, the UE includes, in the first PUCCH transmission, an ID of the first TA value or an ID of a first TAG to which the first TA value is associated. In some implementations, the UE includes, in the second PUCCH transmission, an ID of the second TA value or an ID of a second TAG to which the second TA value is associated.

FIG. 12E illustrates an example method 1200E similar to the scenario 1200A illustrated in FIG. 12A, except that the method 1200E includes blocks 1211E and 1216.

At block 1211E, the UE detects whether the first TAT expires, whether the second TAT expires, and whether both the first TAT and the second TAT expire. If the UE detects that the first TAT expires, the UE performs actions described in blocks 1212B, 1212C, or 1212D. If the UE detects that the second TAT expires, the UE performs actions described in blocks 1214B, 1214C, or 1214D. If the UE detects that both the first TAT and the second TAT expire, the flow proceeds to block 1216. At block 1216, the UE triggers a CBRA procedure with the base station.

Similar to the method 600, more detailed descriptions of elements of the methods 1200A-1200E are generally detailed above.

In some cases, the UE performs an action when at least one of the following is satisfied or achieved: (i) the first TAT is expired; (ii) the UE has UL data or a UL channel/RS, associated with the first index; (iii) the UE has UL data or a UL channel/RS to transmit, which is intended for or associated with the first TRP; and/or (iv) the UE has UL data or a UL channel/RS to transmit via the first TA value. In some such implementations, the action that the UE then performs is at least one of the following actions: (i) triggering or performing a contention-based or contention-free RA procedure associated with the first index; (ii) triggering or performing a contention-based or contention-free RA procedure intended for the first TRP, the first TAG, the first TAT, or the first TA value; and/or (iii) transmitting a first MAC-CE to the NW, where the second TAT is not expired.

In some cases, the UE performs an action when at least one of the following is satisfied or achieved: (i) the second TAT is expired; (ii) the UE has UL data or a UL channel/RS associated with the second index; (iii) the UE has UL data or a UL channel/RS to transmits, which is intended for or associated with the second TRP; and/or (iv) the UE has UL data or aUL channel/RS to transmit via the second TA value. In some such implementations, the action that the UE then performs is at least one of the following actions: (i) triggering or performing a contention-based or contention-free RA procedure associated with the second index; (ii) triggering or performing a contention-based or contention-free RA procedure intended for the second TRP, the second TAG, the second TAT, or the second TA value; and/or (iii) transmitting a second MAC-CE to the NW, where the first TAT is not expired.

In some cases, when an RA procedure is associated with or intended for at least one of (a) the first index and/or (b) the first TRP/TAG/TA value/TAT, at least one of the following is true: (i) the MSG 0 or the PDCCH order (e.g., received by the UE from the base station) for the RA procedure indicates or is associated with the first index, where, in some implementations, the RA procedure is a contention-free RA procedure; (ii) the MSG 1 or the MSG A (e.g., transmitted by the UE to the base station) for the RA procedure indicates or is associated with the first index; (iii) the MSG 2 or the MSG B (e.g., received by the UE from the base station) for the RA procedure indicates or is associated with the first index; and/or (iv) the MSG 3 (e.g., transmitted by the UE to the base station) or the MSG 4 (e.g., received by the UE from the base station) for the RA procedure indicates or is associated with the first index.

In some cases, when an RA procedure is associated with or intended for at least one of (a) the second index and/or (b) the second TRP/TAG/TA value/TAT, at least one of the following is true: (i) the MSG 0 or the PDCCH order (e.g., received by the UE from the base station) for the RA procedure indicates or is associated with the second index, where, in some implementations, the RA procedure is a contention-free RA procedure; (ii) the MSG 1 or the MSG A (e.g., transmitted by the UE to the base station) for the RA procedure indicates or is associated with the second index; (iii) the MSG 2 or the MSG B (e.g., received by the UE from the base station) for the RA procedure indicates or is associated with the second index; and/or (iv) the MSG 3 (e.g., transmitted by the UE to the base station) or the MSG 4 (e.g., received by the UE from the base station) for the RA procedure indicates or is associated with the second index.

In some implementations, the first and/or the second MAC-CE indicates at least one of the following: (i) the first index or the second index, (ii) which TA value or TAG is expired; and/or (iii) an estimated TA offset or difference.

In some cases, when the base station receives the first MAC-CE, the base station transmits a MSG 0 or PDCCH order to the UE. In further implementations, when the NW receives the first MAC-CE, the NW transmits a MSG 0 or PDCCH order to the UE, where: (i) the MSG 0 or the PDCCH order indicates or is associated with the first index, and/or (ii) the MSG 0 or the PDCCH order indicates or is associated with the first index, if the first MAC-CE indicates the first index.

In some cases, when the base station receives the second MAC-CE, the base station transmits a MSG 0 or PDCCH order to the UE. In further implementations, when the NW receives the first MAC-CE, the NW transmits a MSG 0 or PDCCH order to the UE, where: (i) the MSG 0 or the PDCCH order indicates or is associated with the second index, and/or (ii) the MSG 0 or the PDCCH order indicates or is associated with the second index, if the first MAC-CE indicates the first index.

In some implementations, the first and/or the second MAC-CE refers to or is replaced with a TA expiry indication MAC-CE or a TA expiry report MAC-CE. In some implementations, the first and the second MAC-CE are the same MAC-CE. Alternatively, the first and the second MAC-CE are different MAC-CEs.

Turning next to FIG. 13, a UE (e.g., the UE 102) implements an example method 1300 to perform operation of multiple TA values under a multiple-TRP scenario.

The method 1300 begins at block 1302. Blocks 1302, 1304, and 1306 are similar to blocks 602, 604, and 606. At block 1308, the UE starts or restarts a single TAT to maintain a first UL synchronization and a second UL synchronization with the base station. In some implementations, the single TAT is the third TAT mentioned above. At block 1310, the UE detects or determines whether the single TAT expires. At block 1312, the UE, in response to an expiry of the single TAT, performs actions described in 612/614, 712B, 812/814, 912/914, 1012/1014, 1112/1114, 1212A/1214A, 1212B/1214B, 1212C/1212C, 1212D/1214D, and/or 1216.

In some implementations, the UE starts or restarts the single TAT to maintain the first UL synchronization and second UL synchronization with the UE when (e.g., upon, in response to, or after) receiving the first TA value, the second TA value, or both the first TA value and the second TA value.

Similar to the method 600, more detailed descriptions of elements of the method 1300 are generally detailed above.

In some cases (including the method 1300), the UE maintains one TAT (e.g., the third TAT) for the first TA value and the second TA value. In some implementations, the UE maintains one TAT (e.g., the third TAT) for the first TA value and the second TA value, where the third TAT is used to determine whether the first TA value and/or the second TA value is expired.

In some cases, the UE receives a third MAC-CE, where the third MAC-CE indicates or updates the first TA value and the second TA value at the same time. In some implementations, when the UE receives a third MAC-CE, the UE expects that the third MAC-CE indicates or updates the first TA value and the second TA value at the same time. In some implementations, when the UE maintains one TAT (e.g., the third TAT) for the first TA value and the second TA value, the UE expects that the third MAC-CE, if received, indicates or updates the first TA value and the second TA value at the same time.

In some implementations, if the UE receives a third MAC-CE and if the third MAC-CE does not indicate or update the first TA value and the second TA value at the same time, the UE ignores, discards, or otherwise does not use the third MAC-CE. In some implementations, when the UE maintains one TAT (e.g., the third TAT) for the first TA value and the second TA value, if the UE receives a third MAC-CE and if the third MAC-CE does not indicate or update the first TA value and the second TA value at the same time, the UE ignores, discards, or otherwise does not use the third MAC-CE.

In some cases, the base station maintains one TAT (e.g., the third TAT) for the first TA value and the second TA value. In some implementations, the base station maintains one TAT (e.g., the third TAT) for the first TA value and the second TA value, where the third TAT is used to determine whether the first TA value and/or the second TA value is expired.

In some cases, the base station transmits a third MAC-CE, where the third MAC-CE indicates or updates the first TA value and the second TA value at the same time. In some implementations, when the base station transmits a third MAC-CE, the base station may be required to indicate or update the first TA value and the second TA value at the same time. In some such implementations, the base station is not allowed to use the third MAC-CE to only indicate or update one of the first TA value or the second TA value. In some implementations, when the base station maintains one TAT (e.g., the third TAT) for the first TA value and the second TA value, the base station may be required to indicate or update the first TA value and the second TA value at the same time. In some implementations, when the base station maintains one TAT (e.g., the third TAT) for the first TA value and the second TA value, and if the base station transmits the third MAC-CE, the base station may be required to indicate or update the first TA value and the second TA value in the third MAC-CE.

In some implementations, when the UE maintains one TAT (e.g., the third TAT) for the first TA value and the second TA value, the first TA value and the second TA value belong to or are associated with a TAG (e.g., the third TAG). In some implementations, when the UE maintains one TAT (e.g., the third TAT) for the first TA value and the second TA value, the first TA value and the second TA value belong to or are associated with different TAGs respectively (e.g., the first TAG and the second TAG).

In some implementations, the third MAC-CE is one of the following: (i) an (Enhanced) Timing Advance Command MAC CE, (ii) an (Enhanced) Timing Advance Command in an RAR response or in a MAC payload for an RAR response, or (iii) an (Enhanced) Absolute Timing Advance Command in a response to an MSGA transmission including C-RNTI MAC CE.

In some implementations, the third MAC-CE is also used when the UE is configured to maintain and/or maintains two TAT in at least one serving cell (e.g., the first TAT and the second TAT). In some implementations, the third MAC-CE is used to indicate or update the first TA value and/or the second TA value, where: (i) the first TA value and the second TA value are, in some implementations, indicated or updated at the same time; (ii) the first TA value and the second TA value are, in some implementations, indicated or updated separately (e.g., at different time instant); and/or (iii) the first TA value and the second TA value belong to or are associated with different TATs (e.g., the first TAT and the second TAT).

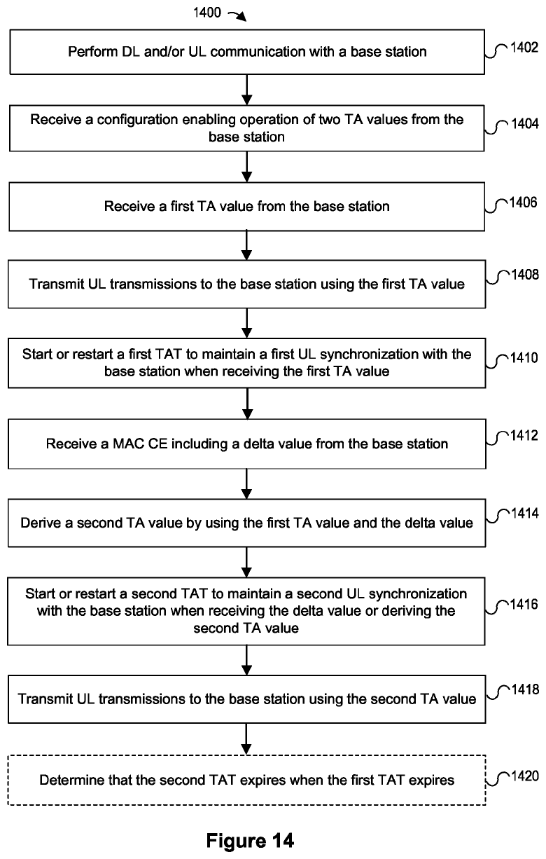

Turning next to FIG. 14, a UE (e.g., the UE 102) implements an example method 1400 to perform operation of multiple TA values under a multiple-TRP scenario.

The method 1400 begins at block 1402. Blocks 1402 and 1404 are similar to blocks 602 and 604. At block 1406, the UE receives a first TA value from the base station. At block 1408, the UE transmits UL transmissions to the base station using the first TA value. At block 1410, the UE starts or restarts a first TAT to maintain a first UL synchronization with the base station when receiving the first TA value. At block 1412, the UE receives a MAC CE including a delta value from the base station. At block 1414, the UE derives a second TA value by using the first TA value and the delta value. At block 1416, in some implementations, the UE starts or restarts a second TAT to maintain a second UL synchronization with the base station when receiving the delta value or deriving the second TA value. At block 1418, the UE transmits UL transmissions to the base station using the second TA value. At block 1420, the UE considers or determines the second TAT expires when the first TAT expires.

Similar to the method 600, more detailed descriptions of elements of the method 1400 are generally detailed above.

In some cases, the UE derives the second TA value. In some implementations, the exact value of the second TA value is not explicitly indicated or signaled by the base station to the UE (e.g., MAC-CE or DCI). In some implementations, the exact value of the first TA value is explicitly indicated or signaled by the base station (e.g., MAC-CE or DCI).

In some implementations, if the UE derives the second TA value, there is no TAT (e.g., a dedicated TAT) for or associated with the second TA value. In some implementations, if the UE derives the second TA value, there is no TAG (e.g., a dedicated TAG) to include or be associated with the second TA value.

In some cases, the UE receives a delta value. In some implementations, the second TA value is derived by using the delta value. In some implementations, the second TA value is derived by using the first TA value and the delta value. In some implementations, the second TA value is the first TA value plus the delta value. In some implementations, the possible value range of the delta value plus the first TA value is the same as or a subset of that of the first TA value. In some implementations, the NW indicates or signals the delta value. In some such implementations, the NW indicates or signals the delta value via one of RRC, MAC-CE, or DCI.

In some implementations, the delta value is indicated or updated by a fourth MAC-CE. The fourth MAC-CE, in some implementations, is the MAC-CE described in the method 1400. In some implementations, the fourth MAC-CE is able to indicate or update the first TA value. In some implementations or alternatively, the fourth MAC-CE is not able to indicate or update the first TA value.

In some implementations, if the UE receives the fourth MAC-CE, and the fourth MAC-CE does not indicate or update a delta value, the currently applied delta value is kept using or is not changed. In some implementations, if (i) the fourth MAC-CE is able to indicate or update the delta value and the first TA value, and (ii) the UE receives the fourth MAC-CE not indicating or updating a delta value, the currently applied delta value is used.

In some implementations, fourth MAC-CE includes a bit or a field to indicate whether the delta value is indicated or updated by the fourth MAC-CE. In some implementations, fourth MAC-CE includes a bit or a field to indicate whether the delta value is present or included in the fourth MAC-CE.

In some implementations, the UE determines that the second TA value is expired or outdated if the first TAT is expired. In some implementations, the UE determines that the delta value is expired or outdated if the first TAT is expired. In further implementations, the base station configures for or indicates to the UE a special timer to determine whether the delta value is expired/outdated or valid. In some implementations, the UE maintains a special timer to determine whether the delta value is expired/outdated or valid. In some implementations, the UE may determines that the second TA value is expired or outdated if the special timer is expired.

It is noted that throughout this disclosure, “a TA value is expired” can refer to at least one of the following: (i) a TA value is not synchronized, (ii) a TA value is outdated, and/or (iii) a TA value is uplink time aligned.

It is noted that throughout this disclosure, a neighboring cell can refer to or be replaced with at least one of the following: (i) a non-serving cell, (ii) a cell with PCI different than a PCI of the serving cell, and/or (iii) a TRP associated with a PCI different from a PCI of the serving cell.

It is noted that throughout this disclosure, a joint TCI state can refer to or be replaced with at least one of the following: (i) a beam applicable for both DL and UL transmission (e.g., DL or UL channel, DL or UL RS, etc.), (ii) a spatial filter for transmission and/or reception, (iii) a spatial parameters for transmission and/or reception, (iv) a spatial relationship for transmission and/or reception, and/or (v) a spatial assumption for transmission and/or reception.

It is noted that throughout this disclosure, a joint TCI state can refer to or be replaced with a common TCI state or a unified TCI state.

It is noted that throughout the document, a UL TCI state can refer to or be replaced with at least one of the following: (i) a UL beam, (ii) a spatial relation, (iii) a spatial transmitting filter, (iv) a transmission precoder, (v) spatial parameters, and/or (vi) a spatial relationship.

It is noted that throughout this disclosure, a DL TCI state may be referred to or replaced with at least one of the following: (i) a TCI applicable for DL channel(s) or RS(s), (ii) a TCI associated with quasi co-location (QCL) type-D, (iii) a QCL assumption, (iv) a DL beam, (v) a spatial receiving filter, (vi) spatial parameters, (vii) a spatial relationship, and/or (viii) a spatial assumption.

It is noted that throughout this disclosure, a TCI pool (e.g., joint TCI pool, UL TCI pool, DL TCI pool) may be referred to or stand for a (RRC) configuration or a list, which may include or contain one or more TCI (index). It is noted that throughout this disclosure, “a TCI” can be referred to or replaced with “a TCI state”. It is noted that throughout this disclosure, “a TCI pool” can be referred to or replaced with “a TCI state pool”.

It is noted that throughout this disclosure, the UE can have one or more of the following attributes or behaviors. The following attributes or behaviors of the UE can also imply associated attributes or behaviors of a base station: (i) The UE is configured with and/or served by the base station in a serving cell. (ii) The UE is configured to communicate with the base station in the serving cell. (iii) The UE is configured with one or more serving cells by the base station, which can include the serving cell. (iv) The UE is activated or indicated, by the base station, to activate one or more serving cells, which can include the serving cell. (v) The UE has configured and/or indicated, by the base station, one or more BWP. The UE has indicated and/or configured, by the base station, a BWP in the serving cell. (a) In some implementations, the BWP is activated as an active BWP; (b) in some implementations, the BWP refers to an active BWP; (c) in some implementations, the BWP is an active DL BWP; (d) in some implementations, the BWP is an active UL BWP; (e) in some implementations, the BWP is an initial BWP; (f) in some implementations, the BWP is a default BWP; (g) in some implementations, the BWP is a dormant BWP. (vi) The UE is in one of RRC_CONNECTED state, RRC_INACTIVE state, or RRC_IDLE state.

It is noted that throughout this disclosure, an expression of “X/Y” may include meaning of “X or Y”. It is noted that throughout this disclosure, an expression of “X/Y” may include meaning of “X and Y”. It is noted that throughout this disclosure, an expression of “X/Y” may include meaning of “X and/or Y”. It is noted that throughout this disclosure, an expression of “(A) B” or “B (A)” may include concept of “only B”. It is noted that throughout this disclosure, an expression of “(A) B” or “B (A)” may include concept of “A+B” or “B+A”.

It is noted that throughout this disclosure, a panel could mean that an antenna (port) group or an antenna (port) set. There may be more than one DL/UL beams associated with one panel. When one transmitting node (UE or base station) is performing a transmission via a panel, only one beam associated with the panel could be used to perform the transmission. For a transmitter comprising more than one panels, e.g., two panels, it may happen that two beams associated with the two panels respectively are used to perform a transmission.

It is noted that throughout this disclosure, a TRP identifier could mean or be referred to as a (candidate) value of a TRP identifier. The first TRP identifier could be a first candidate value of a TRP identifier or a first TRP identifier value. The second TRP identifier could be a second candidate value of a TRP identifier or a second TRP identifier value.

It is noted that throughout this disclosure, a panel identifier could mean or be referred to as a (candidate) value of a panel identifier. The first panel identifier could be a first candidate value of a panel identifier or a first panel identifier value. The second panel identifier could be a second candidate value of a panel identifier or a second panel identifier value.

It is noted that throughout this disclosure, a TCI field could mean or be referred to as a field used or applied or repurposed to indicate one or more TCI states.

It is noted that throughout this disclosure, “joint mode” or “joint TCI state mode” could mean at least one of the following: (i) TCI field(s) or indicated TCI state(s) in a DCI format refer/map to one of joint TCI state pool, DL TCI state pool, or UL TCI state pool; and/or (ii) beam indication(s) or indicated TCI state(s) are applied for both transmitting UL transmission and/or receiving DL transmission.

It is noted that throughout this disclosure, “separate mode” or “separate TCI state mode” could mean at least one of the following: (i) TCI field(s) or indicated TCI state(s) in a DCI format refer/map to one of joint TCI state pool, DL TCI state pool, or UL TCI state pool; and/or (ii) beam indication(s) or indicated TCI state(s) are applied either for (only) transmitting UL transmission or (only) receiving DL transmission.

It is noted that throughout this disclosure, “UL mode” or “UL-only TCI state mode” could mean at least one of the following: (i) TCI field(s) or indicated TCI state(s) in a DCI format refer/map to UL TCI state pool (joint TCI state pool); and/or (ii) beam indication(s) or indicated TCI state(s) are applied for (only) transmitting UL transmission.

It is noted that throughout this disclosure, “DL mode” or “DL-only TCI state mode” could mean at least one of the following: (i) TCI field(s) or indicated TCI state(s) in a DCI format refer/map to DL TCI state pool (joint TCI state pool); and/or (ii) beam indication(s) or indicated TCI state(s) are applied for (only) receiving DL transmission.

It is noted that throughout this disclosure, when a procedure or description is related to a serving cell, it may mean the procedure or description is related to an active (DL/UL) BWP in the serving cell.

It is noted that throughout this disclosure, “a TA timer” or “a TAT” may be referred to or be replaced with “a TA alignment timer”.

It is noted that some or all of the foregoing or the following embodiments could be jointly combined or formed to be a new or another one embodiment.

It is noted that the foregoing or the following embodiments can be used to solve at least (but not limited to) the issue(s) or scenario(s) mentioned in this disclosure.

The following additional considerations may apply to the foregoing and the following discussions.

It is noted that any two or more than two of the foregoing or the following paragraphs, (sub)-bullets, points, actions, or claims described in each method/embodiment/implementation may be combined logically, reasonably, and properly to form a specific method.

It is noted that any sentence, paragraph, (sub)-bullet, point, action, or claim described in each of the foregoing or the following method(s)/embodiment(s)/implementation(s) may be implemented independently and separately to form a specific method. Dependency, e.g., “based on”, “more specifically”, “where” or etc., in the following method(s)/embodiment(s)/implementation(s) is just one possible embodiment which would not restrict the specific method.

It is noted that, some or all of the following terminology and assumption may be used hereafter: (i) Base station (BS): a network central unit or a network node in NR which is used to control one or multiple TRPs which are associated with one or multiple cells. Communication between a base station and TRP(s) is via fronthaul. A base station may be referred to as a central unit (CU), eNB, gNB, or NodeB. (ii) Transmission and reception point (TRP): a transmission and reception point provides network coverage and directly communicates with UEs. A TRP may be referred to as distributed unit (DU) or network node. (iii) Cell: a cell is composed of one or multiple associated TRPs (i.e., coverage of the cell is composed of coverage of all associated TRP(s)). One cell is controlled by one base station. A cell may be referred to as a TRP group (TRPG). (iv) Serving beam: a serving beam for a UE is a beam generated by a network node (e.g., TRP), which is configured to be used to communicate with the UE (e.g., for transmission and/or reception). (v) Candidate beam: a candidate beam for a UE is a candidate of a serving beam. A serving beam may or may not be candidate beam.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for managing synchronization, the method implemented in a user equipment (UE) and comprising:
receiving, from a radio access network (RAN), a configuration including a first timing advance (TA) value and a second TA value;
operating a first TA timer (TAT) corresponding to the first TA value associated with a first primary TA group (PTAG) to manage synchronization of first uplink (UL) transmissions with a first receiver in the RAN;
operating a second TAT corresponding to the second TA value associated with a second PTAG to manage synchronization of second UL transmissions with a second receiver in the RAN;
in response to the first TAT expiring while the second TAT is operating, clearing a first configured UL grant associated with the first TA value; and
in response to the second TAT expiring, clearing a second configured UL grant associated with the second TA value.

2. The method of claim 1, wherein:
the first receiver is a first transmission and reception point (TRP) of a node in the RAN; and
the second receiver is a second TRP of the node;
wherein the UE is configured to communicate with the first TRP and the second TRP in a multiple TRP (M-TRP) mode.

3. The method of claim 2, further comprising:
subsequently to the first TAT expiring and prior to the second TAT expiring, continuing the second UL transmissions to the second TRP.

4. The method of claim 3, further comprising:
wherein the continuing of the second UL transmissions includes continuing to receive, from the RAN, scheduling for the second UL transmissions.

5. The method of claim 2, wherein:
the first TRP is associated with the first PTAG, and
the second TRP is associated with the second PTAG.

6. The method of claim 5, wherein:
the first TA value is associated with a first TCI state, and
the second TA value is associated with a second TCI state.

7. The method of claim 1, wherein:
the first receiver operates in a serving cell ; and
the second receiver operates in a non-serving cell.

8. The method of claim 1, wherein:
operating the first TAT includes starting or restarting the first TAT in response to receiving the first TA value; and
operating the second TAT includes starting or restarting the second TAT in response to receiving the second TA value.

9. The method of claim 1, further comprising:
receiving, from the RAN, an indication that use of multiple TA values in the serving cell is enabled.

10. The method of claim 1, wherein receiving the first TA value includes:
transmitting a random access preamble to the first receiver; and
receiving, from the first receiver and in response to the random access preamble, the first TA vale.

11. The method of claim 1, wherein receiving the first TA value includes:
receiving a Medium Access Control (MAC) control element (CE) including the first TA value.

12. The method of claim 1, wherein receiving the first TA value includes:
receiving a MAC protocol data unit (PDU) including the first TA value.

13. The method of claim 1, further comprising,
in response to the first TAT expiring while the second TAT is operating, transmitting, to the RAN, a first expiration indication that the first TAT expired; and
in response to the second TAT expiring, transmitting, to the RAN, a second expiration indication that the second TAT expired.

14. The method of claim 13, wherein each of the first expiration indication and the second expiration indication is included in a respective MAC CE.

15. A user equipment (UE) comprising:
a transceiver; and
processing hardware; the UE configured to:
receive, from a radio access network (RAN), a configuration including a first timing advance (TA) value and a second TA value;
operate a first TA timer (TAT) corresponding to the first TA value associated with a first primary TA group (PTAG) to manage synchronization of first uplink (UL) transmissions with a first receiver in the RAN;
operate a second TAT corresponding to the second TA value associated with a second PTAG to manage synchronization of second UL transmissions with a second receiver in the RAN;
in response to the first TAT expiring while the second TAT is operating, clearing a first configured UL grant associated with the first TA value; and
in response to the second TAT expiring, clearing a second configured UL grant associated with the second TA value.

16. The method of claim 1, further comprising:
flushing first one or more Hybrid Automatic Repeat reQuest (HARQ) buffers associated with the first UL transmissions, in response to the first TAT expiring; and
flushing second one or more HARQ buffers associated with the second UL transmissions, in response to the second TAT expiring.

17. (canceled)

18. The method of claim 1, further comprising:
releasing first one or more physical uplink control channel (PUCCH) resources associated with the first TA value, in response to the first TAT expiring while the second TAT is operating; and
releasing second one or more PUCCH resources associated with the second TA value, in response to the second TAT expiring.

19. The method of claim 1, further comprising:
releasing a first sounding reference signal (SRS) resource configuration instance associated with the first TA value, in response to the first TAT expiring while the second TAT is operating; and
releasing a second SRS resource configuration instance associated with the second TA value, in response to the second TAT expiring.

20. The method of claim 1, further comprising:
clearing first one or more physical uplink shared channel (PUSCH) resources for semi-persistent (SPS) channel state information (CSI) reporting associated with the first TA value, in response to the first TAT expiring while the second TAT is operating; and
clearing second one or more PUSCH resources for SPS CSI reporting associated with the second TA value, in response to the second TAT expiring.
